(19) United States
(12) Patent Application Publication
(10) Pub. No.: US 2026/0291760 A1
(43) Pub. Date: Sep. 24, 2026

(54) SECURE DEVICE IDENTITY AND FIRMWARE PROVISIONING

(71) Applicant: Medtronic MiniMed, Inc., Northridge, CA (US)

(72) Inventors: Jesus Berian, Porter Ranch, CA (US); Vincent K. Nguyen, Northlake, TX (US); Eduardo Javier Serrano, Valencia, CA (US); Miguel F. Rosales, North Hollywood, CA (US)

(21) Appl. No.: 19/569,981

(22) Filed: Mar. 17, 2026

Related U.S. Application Data
(60) Provisional application No. 63/775,242, filed on Mar. 20, 2025.

(51) Int. Cl. H04L 9/32; H04L 9/08

(52) U.S. Cl. CPC H04L 9/3268; H04L 9/0894; H04L 9/3242

(57) ABSTRACT

A processor-implemented method includes receiving, by an integrated circuit of a device at a first manufacturing site, a firmware comprising information for decrypting a provisioning message, and receiving the provisioning message at a second manufacturing site. The provisioning message includes a payload that is encrypted, the payload including an intermediate certificate authority (CA) identity. The processor-implemented method also includes decrypting the encrypted payload of the provisioning message using the information for decrypting the provisioning message to obtain the intermediate CA identity, and generating a device identity for the device using the intermediate CA identity.

### RELATED APPLICATIONS

This application claims the benefit of U.S. Provisional Application No. 63/775,242, filed Mar. 20, 2025, entitled “SECURE DEVICE IDENTITY AND FIRMWARE PROVISIONING,” which is assigned to the assignee hereof, and incorporated herein in its entirety by reference.

### TECHNICAL FIELD

The present disclosure relates generally to secure identity and firmware provisioning for devices such as low-cost, disposable or non-disposable medical devices.

### BACKGROUND

In systems such as medical systems, devices may use security mechanisms provided by a public key infrastructure (PKI) for data communication and firmware provisioning (or update), due to the sensitive nature of the information being communicated (e.g., personal or health data such as vital signs, physiological parameters, drug delivery data, medical device control algorithms or signals, etc.). A PKI may include one or more computer systems responsible for implementing policies and procedures related to digital certificates and data encryption. Devices in a PKI may each be assigned a unique and secure identity. The identity of a device may include, for example, a key pair for data encryption, and a digital certificate signed by a trusted authority and including a unique number or name identifying the device. The digital certificate may be used for device authentication and authorization. Without a valid identity, a device may be treated as a counterfeit device and thus may not be able to obtain data or firmware from other devices or servers.

### SUMMARY

The present disclosure relates generally to device identity and firmware provisioning. More specifically, techniques disclosed herein relates to secure identity provisioning and in-field firmware updating for devices such as low-cost, disposable or non-disposable medical devices.

According to certain embodiments, a method may include, by an integrated circuit of a device: receiving, at a first manufacturing site, a firmware comprising information for decrypting a provisioning message; receiving the provisioning message at a second manufacturing site, the provisioning message comprising a payload that is encrypted, the payload including an intermediate certificate authority (CA) identity; decrypting, using the information for decrypting the provisioning message, the encrypted payload of the provisioning message to obtain the intermediate CA identity; and generating a device identity for the device using the intermediate CA identity.

According to certain embodiments, a method may include providing a firmware to a first manufacturing site to install the firmware on a controller of a device, the firmware comprising a provisioning application and information for decrypting a provisioning message; and sending the provisioning message to a second manufacturing site to provide the provisioning message to the controller, the provisioning message including a payload that is encrypted, the payload including an intermediate certificate authority (CA) identity. The provisioning application, when executed by the controller, may cause the controller to perform operations comprising, at the second manufacturing site: decrypting, using the information for decrypting the provisioning message, the encrypted payload of the provisioning message to obtain the intermediate CA identity; and generating a device identity for the device using the intermediate CA identity.

According to certain embodiments, a method of installing a firmware on a device may include, by an integrated circuit of the device at one or more manufacturing sites, storing, in a memory space of the integrated circuit, an application for installing the firmware on the integrated circuit using firmware over-the-air (FOTA); and storing a shared identity for FOTA in the memory space. The method may also include, at a user site, executing the application to perform operations comprising: establishing a wireless communication link with a controller; obtaining an encrypted FOTA package from the controller via the wireless communication link, the encrypted FOTA package comprising the firmware; decrypting, using the shared identity for FOTA, the encrypted FOTA package to obtain the firmware; and installing the firmware in the memory space of the integrated circuit.

According to certain embodiments, a processor-implemented method may include, by an integrated circuit of a device: storing, at a first manufacturing site, a first firmware in the integrated circuit, the first firmware including information for decrypting a provisioning message and an application for firmware over-the-air (FOTA); receiving, by the integrated circuit, the provisioning message at a second manufacturing site, the provisioning message including a payload that is encrypted, the payload including a shared identity for FOTA; decrypting, by the integrated circuit using the information for decrypting the provisioning message, the encrypted payload of the provisioning message to obtain the shared identity for FOTA; storing the shared identity for FOTA in the integrated circuit; establishing a wireless communication link with a controller at a user site; obtaining an encrypted FOTA package from the controller via the wireless communication link, the encrypted FOTA package comprising a second firmware; decrypting, using the shared identity for FOTA, the encrypted FOTA package to obtain the second firmware; and installing the second firmware on the integrated circuit.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 illustrates an example of a medical therapy system according to certain embodiments.

FIG. 2A illustrates an example of a certificate trust hierarchy in a public key infrastructure (PKI).

FIG. 2B illustrates an example of an identity of an entity in a public key infrastructure

FIG. 3 illustrates an example of a system including entities in a public key infrastructure.

FIG. 4 illustrates an example of a PKI certificate hierarchy that may be used to generate and manage digital certificates for medical devices distributed by a medical device company.

FIG. 5 illustrates an example of a flow of identity provisioning and enrollment, and firmware provisioning for devices according to certain embodiments.

FIG. 6 illustrates an example of a process of split-trust device identity provisioning and enrollment during manufacturing according to certain embodiments.

FIG. 7 illustrates an example of a process of firmware provisioning according to certain embodiments.

FIG. 8 illustrates an example of a process of firmware provisioning/updating using firmware over-the-air (FOTA) according to certain embodiments.

FIG. 9 illustrates an example of a memory space of a device with an initial (activation) firmware image installed according to certain embodiments.

FIGS. 10A-10E illustrate an example of a process of generating a provisioning message for identity provisioning according to certain embodiments.

FIG. 11 illustrates an example of a memory space of a device with a device identity provisioned according to certain embodiments.

FIG. 12 illustrates an example of a memory space of a device with a therapy firmware provisioned according to certain embodiments.

FIG. 13 illustrates an example of a memory space of an activated device according to certain embodiments.

FIG. 14 includes a flowchart illustrating an example of a method of device identity provisioning during manufacturing according to certain embodiments.

FIG. 15 includes a flowchart illustrating an example of a method of firmware provisioning according to certain embodiments.

FIGS. 16A and 16B depict an example of a glucose sensor device according to certain embodiments, which may implement some of the examples disclosed herein.

FIG. 17 depicts an example of a delivery device, which may implement some of the examples disclosed herein.

FIG. 18 is a simplified block diagram of an example of an electronic device that may implement some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The present disclosure relates generally to device identity and firmware provisioning. More specifically, techniques disclosed herein relates to secure identity provisioning and in-field firmware updating for devices such as low-cost, disposable or non-disposable medical devices.

Devices in medical systems, such as medical devices, servers, and mobile controllers, may each have a unique and secure identity for secured data communication and firmware provisioning (or update). The identity may include, for example, a private key and a digital certificate signed by a certificate authority (CA), and may be used to authenticate and/or authorize the access level of a device. For example, before establishing a secure communication link between two entities (e.g., two medical devices) to transmit data or firmware, each of the two entities may authenticate the identity of the other entity by, for example, verifying that the digital certificate of the other entity is signed by a mutually trusted authority. The digital certificate may include a common name uniquely identifying the device, and a public key generated using the private key. The private key and the public key may be used to encrypt and decrypt data transmitted through the secure communication link established between the two entities. The identity of a device can be provisioned during the manufacturing process, and the digital certificate of the device may be sent to a server to enroll the device. An unenrolled device may not be able to access services provided by the device provider, such as obtaining new or updated firmware from the device provider.

When manufacturing a large quantity of devices (e.g., disposable medical devices), a manufacturer can provide unique identities to the devices using a hardware security module (HSM) in the manufacturing plant, or using Internet connections to another entity that generates and signs the identities for the devices. Using the HSM to store secure identities may be costly because the manufacturer may need to meet specific physical (and logical) security requirements, such as periodic audits, specific secure facilities and maintenance, and the like. Identity provisioning through Internet connections to another entity may have a lower cost, but may cause production line shutdown in the event of Internet connection failure, since the devices in the production line may not be able to obtain an identity from other entities to finalize the manufacturing process.

In addition, for disposable devices that may have a short life time, it may be desirable to minimize the cost of bill of material and manufacturing processes. For example, the disposable device may have reduced hardware resource such as memory space and processing power. Therefore, the disposable device may not be able to hold two full images to perform a secure firmware update, and may not implement complex cryptographic algorithms. It may be desirable to development techniques that can use small memory and processing power to provision or update a therapy firmware at least once through firmware over-the-air (FOTA) in a secure manner to ensure that the medical device uses the most up-to-date firmware.

According to certain embodiments disclosed herein, the identity provisioning in the manufacturing process may be split into two or more separate operations performed at respective manufacturers without using HSMs or continuous Internet connections. A device may generate its own identity based on information received separately at two or more manufacturers. But neither manufacturer would be able to generate and provision unique identities to devices manufactured by the manufacturer. For example, a first manufacturer may install an activation firmware (an initial firmware) on an integrated circuit (e.g., a processor, a microcontroller unit, or a system-on-chip (SOC)), and then lock the integrated circuit so that the internal memory of the integrated circuit storing the activation firmware may not be read by another entity outside of the integrated circuit. The activation firmware may include a provisioning application and secrets (e.g., a key) to decrypt an encrypted provisioning message. But the first manufacturer may not have a provisioning message. A second manufacturer (e.g., a last manufacturer) of the device may receive an encrypted provisioning message, but may not be able to read the secrets from the device to decrypt the encrypted provisioning message and thus could not generate the identity. The second manufacturer may provide the provisioning message to the integrated circuit, which may execute the provisioning application to decrypt the encrypted provisioning message and generate the unique identity for the device using the provisioning message.

In one example, the devices may be disposable devices and may have an expected expiration date. An identity of an intermediate CA that may only be valid for a short period of time (rather than a long lasting CA) may be generated and provided to the second manufacturer in the form of an encrypted and signed provisioning message, so that a microcontroller unit (MCU) of a device may validate and decrypt the provisioning message to generate its own identity based on the identity of the intermediate CA. The first manufacturer may be a chip manufacturer that may only have access to an initial firmware including a bootloader for performing the provisioning operations and information for decrypting the provisioning message, but may not have access to the provisioning message. The information for decrypting the provisioning message may be a shared identity for provisioning. The first manufacturer may install the initial firmware on the MCU and lock the MCU so that the initial firmware would not be read back from the MCU by another entity. The second manufacturer may be a printed circuit board assembly (PCBA) manufacturer or device assembler. The second manufacturer may receive the encrypted provisioning message in advance from the device company and provide the encrypted provisioning message to the MCU (which is locked), so that the MCU can internally generate its own identity using the identity of the intermediate CA obtained from the provisioning message, and securely delete the shared identity for provisioning from its memory space. The second manufacturer may not have access to the initial firmware, and thus may not have access to information for decrypting the provisioning messages. The second manufacturer may store the digital certificates outputted by a batch of manufactured devices and send the stored digital certificates together to a device provider to enroll the devices.

Therefore, techniques disclosed herein may split the trust between manufacturers so that neither manufacturer may be able to generate and provision unique identities to devices manufactured at the manufacturer. Each manufacturer's involvement in the device identity provisioning process is limited, and neither manufacturer may have access to sensitive data or cryptographic materials (e.g., private key of an intermediate CA for signal the certificate of the device identity). In addition, the identity of the intermediate CA may be transmitted via (double) encrypted and signed messages, and the identity of the intermediate CA may only be valid for a short period of time (e.g., may be changed every a few months), thereby allowing tracing the manufacturer of a given device and mitigating losses even if the identity of an intermediate CA is compromised. Therefore, security may be improved during the provisioning process. Furthermore, since the encrypted intermediate CA messages may be sent in advance to the manufacturer, the manufacturing process would not stop even if Internet connection were lost, and no HSM may be used to store pre-generated identities. Therefore, the cost in manufacturing disposable medical devices may be reduced and the risk of production losses due to the lack of Internet connection may be eliminated.

According to certain embodiments disclosed herein, during manufacturing, a device (e.g., a medical device) may be provided with a bootloader to support at least one full FOTA process, and a shared FOTA identity that can be used to decrypt a signed and encrypted firmware image received after the manufacturing. The device may be received by a user without a therapy firmware. A mobile device may be used for downloading (or pre-downloading and storing) the latest firmware for the type of device before the first use of the device. This may ensure that the firmware is the most up-to-date firmware (e.g., per FDA requirement). During pairing and initialization of the device with the mobile device in the field before the first use of the device, the encrypted therapy firmware is loaded onto the device via FOTA, and the bootloader may decrypt the encrypted therapy firmware images from the mobile device using the shared FOTA identity, install the therapy firmware, and erase the shared FOTA identity. Once the medical device is programmed with the therapy firmware and rebooted, the bootloader may be erased (e.g., replaced with history and traces), and the device may be activated with the therapy firmware launched.

For purposes of illustration and explanation, various examples described in this disclosure are related to medical devices, including insulin or fluid delivery devices, glucose measuring devices, and the like. Even though some examples described herein involve secure identity and firmware provisioning for medical devices in medical therapy systems, techniques disclosed herein can be applied to other environments and can be used in other systems that use unique identities for secured data communication and firmware provisioning (or firmware update), including non-medical systems that include other sensors and communication devices, such as some disposable or low-cost sensors.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, operations, and techniques may be shown without necessary detail or may not be shown, in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs. Illustrative examples of systems, devices, and methods embodying aspects of these techniques are described with reference to the accompanying drawings. The embodiments can be combined in different ways and modified/adapted as appropriate depending on application.

The pancreas of a healthy person can produce and release insulin into the blood stream in response to elevated blood glucose levels. More specifically, beta cells (β-cells) in the pancreas can produce and secrete insulin into the blood stream as needed. If β-cells become incapacitated or die (a condition known as Type 1 diabetes mellitus), the naturally produced insulin in the body may not be sufficient to control the glucose level in the blood stream of the patient, due to insufficient production of insulin and/or insulin resistance. Therefore, a diabetic patient may need to receive insulin from a pump or another delivery device, such as an injection device (e.g., a syringe) or an infusion device (e.g., an infusion pump), to control the glucose level in the patient's blood stream. To control the glucose level, a diabetic patient's therapy routine may generally include dosages of basal insulin and bolus insulin.

Some blood glucose level management systems may be closed-loop systems that may include a pump automatically or semi-automatically controlled to deliver insulin to the patient. Some blood glucose level management systems may require manual administration of insulin based on dosage determined by an insulin calculator. The delivery of insulin to the patient can be controlled to occur at time instants and in amounts that are determined based on, for example, the amount of carbohydrates taken by a patient and/or real-time measurements of glucose levels by a glucose sensor, such as a fingerstick blood glucose measurement device, a flash glucose sensor, or a continuous glucose monitoring (CGM) sensor. In many circumstances (e.g., in a diabetic patient), it may be beneficial to monitor glucose levels on a continuing basis. Such information can be useful in monitoring and/or adjusting a treatment regimen, which typically includes administration of insulin to the patient. Rather than continuously sampling and monitoring a user's blood glucose level, which may compromise battery life, intermittently sensed glucose data samples may often be utilized for purposes of continuous glucose monitoring (CGM) or determining operating commands for the infusion pump. A CGM sensor may use measurement results (e.g., currents, voltage levels, resistance, etc.) from a sensor inserted into the subcutaneous layer of a user to estimate the blood glucose level of the user based on the glucose level in the interstitial fluid (ISF). In some implementations, a glucose sensor may produce signals through a series of electrochemical reactions when the sensor is inserted and exposed to glucose and oxygen diffused from the interstitial fluid.

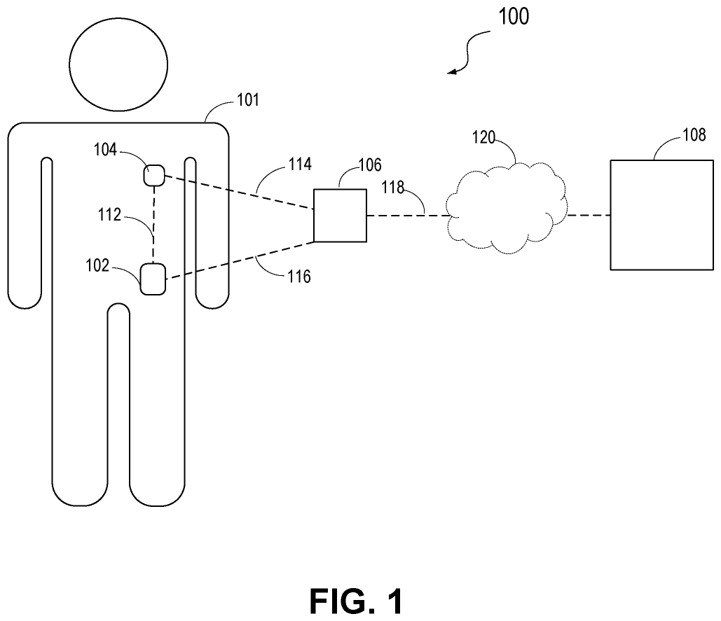

FIG. 1 illustrates an example of a medical therapy system 100 according to certain embodiments. Medical therapy system 100 may be used to, for example, monitor and regulate the blood glucose level of a patient 101. In the illustrated example, medical therapy system 100 may include a delivery device 102, a monitoring device 104, a computing device 106, and an optional remote/cloud computing system 108. Delivery device 102, monitoring device 104, and computing device 106 may be embodied in various ways, including being disposed in one or more device housings. For example, in some embodiments, all of devices 102-106 may be disposed in a single device housing. In some embodiments, each of devices 102-106 may be disposed in a separate device housing. In some embodiments, two or more of devices 102-106 may be disposed in the same device housing. In some embodiments, a single device 102, 104, or 106 may have two or more parts that are disposed in two or more housings. For example, monitoring device 104 may include an on-body part and a display and control part communicated with the on-body part through wires or wirelessly. Delivery device 102 may include an on-body site (e.g., including a cannula) and a part that includes a reservoir, a pump, and a control unit. These and other embodiments, and combinations thereof, are contemplated to be within the scope of the present disclosure.

Medical therapy system 100 may include a plurality of communication links, such as communication links 112-118. Communications links 112-118 may each be a wired connection and/or a wireless connection. In embodiments where two devices are located in a same housing, the communication link may include, for example, wires, cables, and/or communication buses on a printed circuit board, among other things. In embodiments where two devices are separate from each other in different device housings, the communication links may be wired and/or wireless connections. Wired connections may include, for example, an Ethernet connection, a Universal Serial Bus (USB) connection, and/or another type of physical connection. Wireless connections may include, for example, a cellular connection, a Wi-Fi connection, a Bluetooth® connection, a mesh network connection, and/or another type of connection using a wireless communication protocol. Some embodiments of communication links 112-118 may use direct connections, such as Bluetooth® connections, and/or may use connections that route through one or more networks or network devices (not shown), such as an Ethernet network, a Wi-Fi network, a cellular network, a satellite network, an intranet, an extranet, the Internet, and/or the Internet backbone, among other types of networks. Various combinations of wired and/or wireless connections may be used for communication links 112-118.

Delivery device 102 may be configured to deliver a therapeutic substance to patient 101. The therapeutic substance may include, for example, insulin, HIV drugs, drugs to treat pulmonary hypertension, iron chelation drugs, pain medications, anti-cancer treatments, medications, vitamins, hormones, a nutritional supplement, a dye, a tracing medium, a saline medium, a hydration medium, and the like. Delivery device 102 may be secured to patient 101 (e.g., to the body or clothing of patient 101) or may be at least partially implanted in the body of patient 101. In some embodiments, the delivery device 102 may include a reservoir, an actuator, a delivery mechanism, and a cannula (not shown). The reservoir may be configured to store an amount of the therapeutic substance. In some embodiments, the reservoir may be refillable or replaceable. The actuator may be configured to drive the delivery mechanism. In some examples, the actuator may include a motor, such as an electric motor. The delivery mechanism may be configured to move the therapeutic substance from the reservoir through the cannula. In some examples, the delivery mechanism may include a pump and/or a plunger. The cannula may facilitate a fluidic connection between the reservoir and the body of patient 101. The cannula and/or a needle may facilitate delivery of the therapeutic substance to a tissue layer, vein, interstitial fluid, or body cavity of patient 101. During operation, the actuator, in response to a signal (e.g., a command signal), may drive the delivery mechanism, thereby causing the therapeutic substance to move from the reservoir, through the cannula, and into the body of patient 101.

The components of delivery device 102 described above are merely provided as an example. Delivery device 102 may include other components, such as, without limitation, a power supply, a communication transceiver, one or more processors or other computing resources, memory devices, and/or user interfaces (e.g., buttons, keys, display, etc.), among other things. In some implementations, delivery device 102 may host an App (e.g., an insulin calculator) that may calculate the desired amount of therapeutic substance to be delivered to patient 101. Persons skilled in the art will recognize various implementations of delivery device 102 and the components of such implementations. All such implementations and components are contemplated to be within the scope of the present disclosure.

Monitoring device 104 may be configured to detect a physiological condition (e.g., a glucose concentration level) of patient 101 and may also be configured to detect other things. Monitoring device 104 may be secured to the body of patient 101 (e.g., to the skin of patient 101 via an adhesive) and/or may be at least partially implanted into the body of patient 101. Depending on the particular location or configuration, monitoring device 104 may be in contact with biological matter (e.g., interstitial fluid and/or blood) of patient 101.

Monitoring device 104 may include one or more sensors (not shown), such as, without limitation, electrochemical sensors, electrical sensors, and/or optical sensors. As persons skilled in the art will understand, an electrochemical sensor may be configured to respond to the interaction or binding of a biological marker to electrodes by generating an electrical signal based on, for example, a potential, conductance, current, and/or impedance of an electrical path through the electrodes. The electrodes may include a material selected to interact with a particular biomarker, such as glucose. The potential, current, conductance, and/or impedance may correlate with a concentration of the particular biomarker. In one example, the electrochemical sensor may include a glucose limiting membrane (GLM) that limits the amount of glucose and oxygen delivered to a glucose oxidase (GOx) layer of a working electrode of the sensor to ensure that the reactions are glucose limited. The GOx layer or another active enzyme layer on the working electrode of the sensor may break down glucose and oxygen into gluconic acid and hydrogen peroxide. The generated peroxide molecules may interact with the working electrode to break down hydrogen peroxide into two hydrogen ions, oxygen, and two electrons at the surface of the working electrode, when a voltage signal is supplied to the working electrode. The electrical charges may be forced to move between electrodes (e.g., between the working electrode and counter electrode), thereby generating a sensor current signal (Isig) that can be measured by sensor electronics. Other signals such as the counter voltage (Vcntr, the voltage potential difference between the counter electrode and the working electrode), electrochemical impedance spectroscopy (EIS) at different frequencies, and the like, may also be measured. The signals measured using the sensor, including the Isig, Vcntr, and EIS, may be processed (e.g., filtered or transformed) to generate some other signals or parameters, such as filtered Isig signals, real and imaginary impedance at various frequencies, and the like. These signals and/or the processed parameters may be used in one or more sensor glucose (SG) models (e.g., machine learning models or mathematical models) to determine SG values that may be estimations of the blood glucose (BG) levels of the patient.

As persons skilled in the art would understand, an electrical sensor may be configured to respond to an electrical biosignal by generating an electrical signal based on an amplitude, frequency, and/or phase of the electrical biosignal. The electrical biosignal may include a change in electric current produced by the sum of an electrical potential difference across a tissue, such as the nervous system, of patient 101. In some embodiments, the electrical biosignal may include portions of a potential change produced by the heart of patient 101 over time (e.g., recorded as an electrocardiogram) that may be indicative of a glucose level of patient 101. An optical sensor may be configured to, for example, respond to the interaction or binding of a biological marker to a substrate by generating an electrical signal based on change in luminance of the substrate. In one example, the substrate may include a material selected to fluoresce in response to contact with a selected biomarker, such as glucose. The fluorescence may be proportional to a concentration of the selected biomarker.

In some embodiments, monitoring device 104 may include other types of sensors that may be worn, carried, or coupled to patient 101 to measure activity of patient 101 that may influence the glucose levels or glycemic response of patient 101. As an example, the sensors may include an acceleration sensor configured to detect an acceleration of patient 101 or a portion of the patient 101, such as the person's hands or feet, the position changes of which may be associated with an activity of patient 101. For example, the acceleration or movement (or lack thereof) of the body portion of patient 101 may be indicative of exercise, sleep, or food/beverage consumption activity of patient 101, which may influence the glycemic response of patient 101. In some embodiments, the sensors may measure heart rate and/or body temperature, which may indicate an amount of physical exertion experienced by patient 101. In some embodiments, the sensors may include a Global Positioning System (GPS) receiver which may detect GPS signals to determine a location of patient 101.

The sensors described above are merely provided as examples. Other sensors or types of sensors for monitoring physiological condition, activity, and/or location, among other things, will be recognized by persons skilled in the art and are contemplated to be within the scope of the present disclosure. For any sensor, the signal provided by a sensor may be referred to herein as a “sensor signal.” As used herein, the term “sensed data” may mean and include the information represented by a sensor signal or by a pre-processed sensor signal. In some embodiments, sensed data may include glucose levels of patient 101, acceleration of a part of patient 101, heart rate of patient 101, temperature of patient 101, and/or geolocation (e.g., GPS location) of patient 101, among other things. Monitoring device 104 may communicate sensed data to delivery device 102 via communication link 112 and/or to computing device 106 via communication link 114. Use of sensed data by delivery device 102 and/or by computing device 106 is described in more detail below.

In some embodiments, monitoring device 104 may include components and/or circuitry configured to pre-process sensor signals. Pre-processing may include, for example, amplification, filtering, attenuation, scaling, isolation, normalization, transformation, sampling, and/or analog-to-digital conversion, among other things. In some embodiments, monitoring device 104 may host an App for process the sensor signals. In some embodiments, monitoring device 104 may include a wired or wireless transceiver as described above for transmitting the sensor signals or receiving commands or instructions. Persons skilled in the art will recognize various implementations for such pre-processing, including, without limitation, implementations using processors, controllers, integrated circuits, application specific integrated circuits (ASICs), hardware, firmware, programmable logic devices, and/or machine-executable instructions, among others. The types of pre-processing and their implementations are merely provided as examples. Other types of pre-processing and implementations are contemplated to be within the scope of the present disclosure. In some embodiments, monitoring device 104 may not perform pre-processing.

Computing device 106 may provide processing capabilities and may be implemented in various ways. In some embodiments, computing device 106 may be a consumer device, such as a smartphone, a computerized wearable device (e.g., a smartwatch), a tablet computer, a laptop computer, or a desktop computer, among others, or may be a special purpose device (e.g., a portable control device) provided by, for example, the manufacturer of delivery device 102. In some embodiments, computing device 106 may be processing circuitry that may be integrated with another device, such as delivery device 102. In some embodiments, computing device 106 may be secured to patient 101 (e.g., to the body or clothing of patient 101), may be at least partially implanted into the body of patient 101, and/or may be held by patient 101.

For each of the embodiments of computing device 106, computing device 106 may include various types of logic circuitry, including, but not limited to, microprocessors, controllers, digital signal processors (DSPs), application specific integrated circuits (ASICs), field-programmable gate arrays (FPGAs), central processing units (CPU), graphics processing units (GPU), programmable logic devices, memory (e.g., random access memory, volatile memory, non-volatile memory, etc.), or other discrete or integrated logic circuitry, as well as combinations of such components. The term “processing circuitry” may generally refer to any of the foregoing logic circuitry, alone or in combination with other logic circuitry, or any other circuitry for performing computations.

Some aspects of delivery device 102, monitoring device 104, and computing device 106 have been described above. One or more of devices 102-106 may include a user interface (not shown) that presents information to patient 101 and/or receives information from patient 101. The user interface may include a graphical user interface (GUI), a display device, a keyboard, a touchscreen, a speaker, a microphone, a vibration motor, buttons, switches, and/or other types of user interfaces. Persons skilled in the art will recognize various types of user interfaces that may be used, and all such user interfaces are contemplated to be within the scope of the present disclosure. For example, where computing device 106 is a consumer device such as a smart phone, tablet computer, laptop computer, or the like, the user interfaces would include a display device, a physical and/or virtual keyboard, and/or audio speakers provided by such consumer devices, among other things. In some embodiments, a user interface may notify patient 101 of sensed data (e.g., glucose level) and/or insulin delivery data (e.g., rates of historic, current, or future insulin delivery) and may present alerts to patient 101. In some embodiments, a user interface may receive inputs from patient 101, which may include, for example, a requested change in insulin delivery setting and/or a meal indication, among other things. The descriptions and embodiments above regarding user interfaces are merely provided as examples, and other types and other uses of user interfaces are contemplated to be within the scope of the present disclosure.

In one specific example, the communications between devices 102-106 and cooperation between devices 102-106 may be used for insulin delivery. As depicted in FIG. 1 and as described above, devices 102-106 may communicate with each other via communication links 112-116. In some embodiments, computing device 106 may control operations of delivery device 102 and/or monitoring device 104. For example, computing device 106 may generate one or more signals (e.g., a command signal) that cause delivery device 102 to deliver insulin to patient 101, for example, as a basal dosage and/or a bolus dosage. In some embodiments, computing device 106 may receive data associated with insulin delivery (e.g., insulin delivery data) from delivery device 102 and/or receive sensed data (e.g., glucose levels) from monitoring device 104, and may perform computations based on the insulin delivery data, the sensed data, and/or other data to control delivery device 102. Insulin delivery data may include, but is not limited to, the type of insulin being delivered, historical insulin delivery rates and/or amounts, current insulin delivery rate and/or amount, insulin delivery time, and/or user inputs affecting insulin delivery. As persons skilled in the art will understand, in a closed-loop operating mode, computing device 106 may communicate dosage commands to delivery device 102 based on, for example, a difference between a current glucose level in the body of patient 101 (e.g., received from monitoring device 104) and a target glucose level (e.g., determined by computing device 106 or set on delivery device 102). The dosage commands may indicate an amount of insulin to be delivered and/or a rate (or time) of insulin delivery, and may regulate the current glucose level toward the target glucose level.

Remote/cloud computing system 108 may be any proprietary remote/cloud computing system or a commercial cloud computing system including one or more server computing devices. Remote/cloud computing system 108 may provide alternative or additional computing resources as needed when the computing resources of a client computing device (e.g., computing device 106) are not sufficient. Computing device 106 and remote/cloud computing system 108 may communicate with each other through a communication link 118, which may traverse one or more communication networks 120. Communication networks 120 may include, for example, an Ethernet network, a Wi-Fi network, a cellular network, a satellite network, an intranet, an extranet, the Internet, and/or the Internet backbone, among other types of networks. Persons skilled in the art will recognize implementations for remote/cloud computing system 108 and how to interface with such systems through various types of networks. For example, remote/cloud computing system 108 may include an array of processing circuitry and may execute machine-readable instructions. Such implementations, interfaces, and networks are contemplated to be within the scope of the present disclosure.

In some embodiments, remote/cloud computing system 108 may make a therapy determination (e.g., an insulin amount or adjusted insulin amount), and may communicate the therapy to delivery device 102 via computing device 106. In some embodiments, computing device 106 may make the therapy determination and communicate it to delivery device 102. In some embodiments, monitoring device 104 may make the therapy determination and communicate it to delivery device 102 either directly or through an intermediary such as computing device 106.

In some embodiments, remote/cloud computing system 108 may store information of medical devices and users, such as medical device identification information and authorization information, user login information, and user medical history data. In some embodiments, remote/cloud computing system 108 may store firmware for medical devices such as delivery device 102 and monitoring device 104. The firmware may include therapy firmware to be installed on medical devices to control operations of medical devices, and mobile apps that may be executed on a mobile device associated with one or more medical device, such as computing device 106. For example, remote/cloud computing system 108 may store mobile apps that may be executed on a smartphone or tablet, which may be wirelessly paired with delivery device 102 and/or monitoring device 104. The smartphone or tablet with the installed mobile app may interface with delivery device 102 and/or monitoring device 104, and may function as, for example, a controller for delivery device 102 or monitoring device 104, a primary display for delivery device 102 or monitoring device 104, or an intermediatory device for transferring therapy parameters from remote/cloud computing system 108 to delivery device 102, transferring therapy and/or user physiological data to remote/cloud computing system 108, or delivering updates to firmware used on delivery device 102 or monitoring device 104 via firmware over-the-air (FOTA). In some examples, in addition to therapy services, remote/cloud computing system 108 may provide some security services, such as public key infrastructure (PKI) and security device registration services, certificate enrollment and renewal services, authority renewal services, secure session services, encryption and decryption services; firmware eligibility service, firmware distribution service, and the like.

As described above, medical therapy system 100 may include web applications, cloud services, mobile platforms, mobile applications, embedded medical devices, and other components or entities. For example, a diabetic therapy system may deliver diabetic therapy to patients using glucose sensors, insulin pumps, mobile platforms, and cloud services. Because of the different technologies used by different entities of the system, it can be challenging to securely integrate the entities and securely transfer data among the different entities. To ensure the integrity of the medical therapy system for safe therapy delivery and the confidentiality of patient health data and private identifiable information of the entities of the system, the different entities in the system may have unique identities to authenticate the entities, authorize the entities for appropriate access levels based on privileges, and establish secure communication links between entities for secured data communication and firmware provisioning (or firmware update) using various encryption techniques. The authentication may help to ensure that entities will interact only with other authentic entities. The authorization may help to ensure that authenticated entities are allowed to perform operations that they are authorized to do. Authenticated entities may also use encryption to prevent breaches in confidentiality and integrity.

In some examples, the unique identity for authenticating and/or authorizing the access level of an entity may include a private key and a digital certificate signed by a trusted certificate authority (CA). Before establishing a secure communication link between two entities (e.g., two medical devices) to transmit data or firmware, each of the two entities may authenticate the identity of the other entity by, for example, verifying that the digital certificate of the other entity is signed by a mutually trusted certificate authority. The digital certificate may include a common name uniquely identifying the device, and a public key generated using the private key. The private key and the public key may be used to encrypt and decrypt data transmitted through the secure communication link established between the two entities. The identity of a device can be provisioned during the manufacturing, and the digital certificate of the device may be sent to a server to enroll the device. An unenrolled medical device may be treated as a counterfeit device and may not be able to access services provided by the device provider, such as obtaining therapy firmware.

A public key infrastructure (PKI) may be used to generate digital certificate and provide authentication among entities that trust a set of authorities that include a mutually trusted certificate authority. A PKI may include a set of roles, policies, and procedures that may be used to create, manage, distribute, use, store, and revoke digital certificates and manage public-key encryption. The purpose of a PKI is to facilitate secure electronic transfer of information for a range of network activities. One example of the PKI is the public-key infrastructure using X.509 (PKIX) standard described in Network Working Group Request for Comments: 5280 (RFC 5280) that may be used to generate X.509 certificates.

In the public key infrastructure, a certificate authority may be responsible for enrolling other entities into the same public key infrastructure by signing their certificates. The certificate authority is responsible for validating the identity of an entity requesting a certificate as well as revoking certificates of entities which may have exposed private keys. All entities in the same PKI store a set of authority certificates which they trust in their trust stores. Before establishing secure communication, each entity in the PKI can authenticate each other's identity by verifying that their certificates are signed by a mutually trusted authority. A digital signature signed by a certificate authority is a value which proves that the content has originated from an expected source and has not been tampered during transit. In one example, a digital signature may be generated by computing a hash of the message before encrypting the hash with a private key, and the signature may be verified by computing the hash of the message and comparing it to the result of decrypting the signature with the public key. The signing may be done by the source of the message, while the authentication may be done by the recipient of the message for verification. A digital signature may prove authenticity but not confidentiality because third parties can still read the message but cannot change it without detection.

A PKI may use public key cryptography (also referred to as asymmetric key cryptography) for data encryption and decryption. The public key cryptography may use pairs of public and private keys to encrypt and decrypt data sent across insecure channels such as the Internet. One key in a pair of public and private keys may be a public key that may be shared publicly. The other key in the pair may be a private key that is kept private. The public key may generally be generated based on the private key. Either one of the private key and the public key can be used to encrypt data, and the other key may be used to decrypt the encrypted data. For example, if one entity uses a public key to encrypt a message, only the private key corresponding to that public key (in a unique key pair) may be used to decrypt the message. Conversely, if a private key is used to encrypt a message, only the public key corresponding to the private key can be used to decrypt the message. This one-way function allows authentication and encryption over insecure channels in a public key infrastructure. Some widely used examples of public key cryptography include RSA (Rivest-Shamir-Adleman) and ECC (elliptic-curve cryptography).

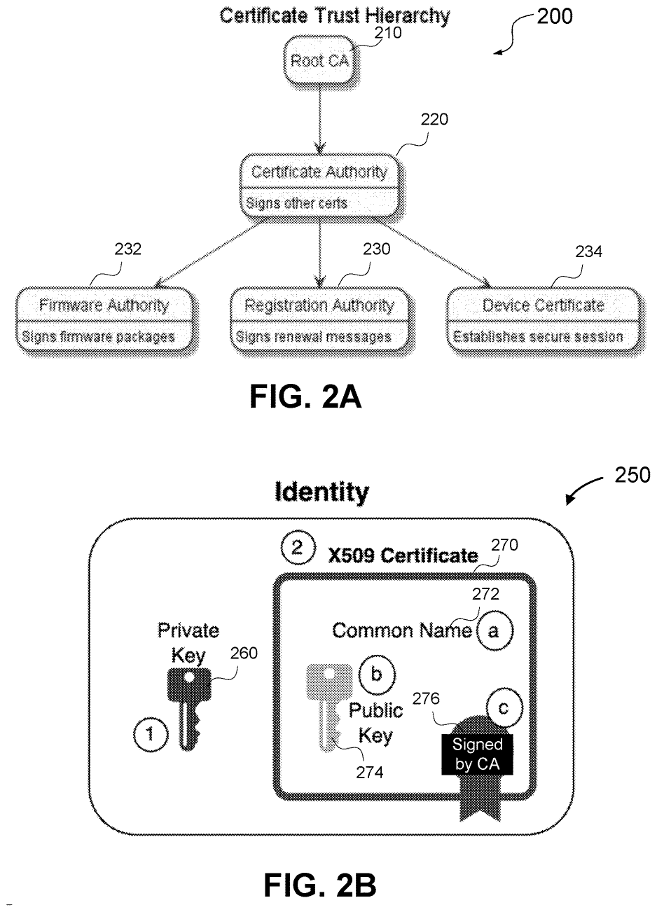

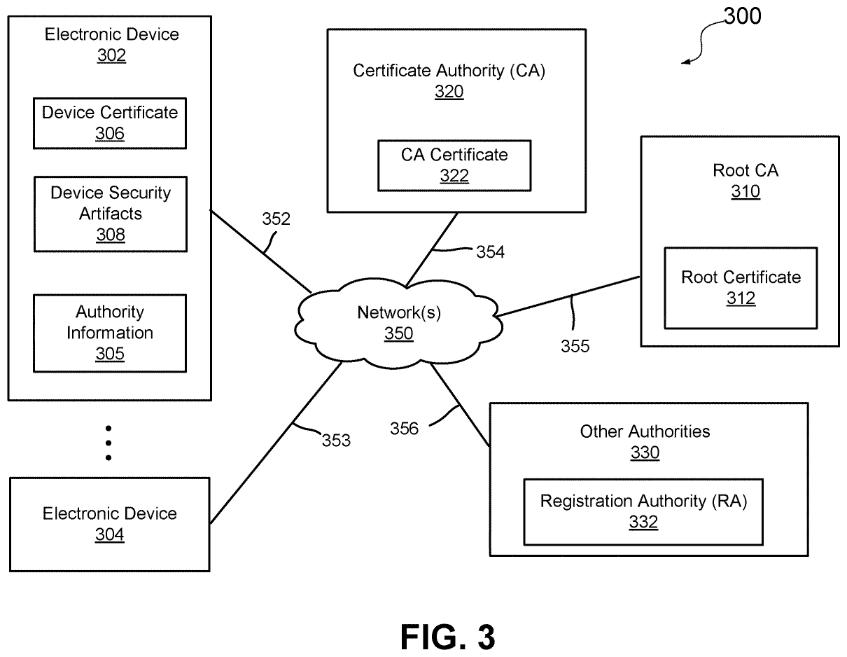

FIG. 2A illustrates an example of a certificate trust hierarchy 200 in a public key infrastructure. Certificate trust hierarchy 200 shows the chain of trust used in a system and recognized by each component of the system. In the illustrated example, certificate trust hierarchy 200 includes a root certificate authority 210 and one or more certificate authorities 220. Root certificate authority 210 is the root of trust in the PKI and may issue authority certificates to one or more certificate authorities 220. Root certificate authority 210 may have the highest level of trust in the PKI and may have a long validity period. The private key of root certificate authority 210 is kept offline and physically protected, and may be used to issue new authority certificates to certificate authorities 220. Each authority certificate may be saved in a trust store. A certificate authority 220 may issue certificates for one or more of a registration authority 230, a firmware authority 232, or a device 234 (e.g., a medical device such as a medical sensor or infusion device). Registration authority 230 may sign renewal messages and new certificates for some of the other authorities. Firmware authority 232 may sign firmware packages for device 234. Device 234 may generate its own device certificate which may eventually be signed by certificate authority 220. The device certificate may be used to authenticate device 234 and establish trust between device 234 and other devices in the PKI. Devices 234 may only trust messages signed by the appropriate authority. An entity that issues a digital certificate may be authorized to do so on a time-limited basis, in which case the issuer may need to periodically renew its own credentials (e.g., a new CA certificate) in order to continue issuing device certificates.

In one example, a device certificate may be based on certificate standard X.509 and a public key encryption algorithm (e.g., 256-bit elliptic curve digital signature algorithm (ECDSA) with the curve SECP25R1), the key exchange algorithm may be elliptic curve Diffie-Hellman with ephemeral keys (ECDHE), the signed message format may be PKCS#7 (RFC2315), and the signing algorithm may be ECDSA signature with a secure hash algorithm with 256 bits (SHA 256) hash.

FIG. 2B illustrates an example of an identity 250 of an entity in a system having a public key infrastructure. In the illustrated example, identity 250 may include a private key 260 (e.g., an elliptic-curve cryptography (ECC) private key) and a digital certificate 270. As described above, for security, certificate trust hierarchy 200 of the public key infrastructure may be used to generate the digital certificate used to establish identity in the authentication and authorization process. The digital certificate may be signed by a private key but may not contain a private key. In some examples, the private key used to sign the certificate is paired with the public key inside the certificate, and thus the certificate is self-signed. In some examples, the digital certificate may be signed by the private key of another certificate (such as a certificate authority). A certificate chain as shown in FIG. 2A is formed when one entity signs the certificate of another entity.

In the illustrated example, digital certificate 270 may be an X.509 certificate and may include a common name 272 uniquely identifying the entity (e.g., a medical device), a public key 274 for the entity, and a signature 276. In one example, common name 272 may include the name of a manufacturer, a device type, and an unique identifier (UID), and may be coded to allow certificate segmentation. The UID may be a numeric or alphanumeric string (e.g., a serial number) that is associated with the entity within the system and may be unique among all identifiers used in the system. Public key 274 may be a public key (e.g., an ECC public key) generated using private key 260. Digital certificate 270 is signed by an issuer (e.g., a CA or an intermediate CA), and signature 276 may be used for authentication. In one example, signature 276 may be an elliptic curve digital signature algorithm (ECDSA) signature. Even though not shown in FIG. 2B, digital certificate 270, such as the X.509 certificate, may include other fields, such as fields for identifying the device, the issuer, the issuance date, and/or the expiration date.

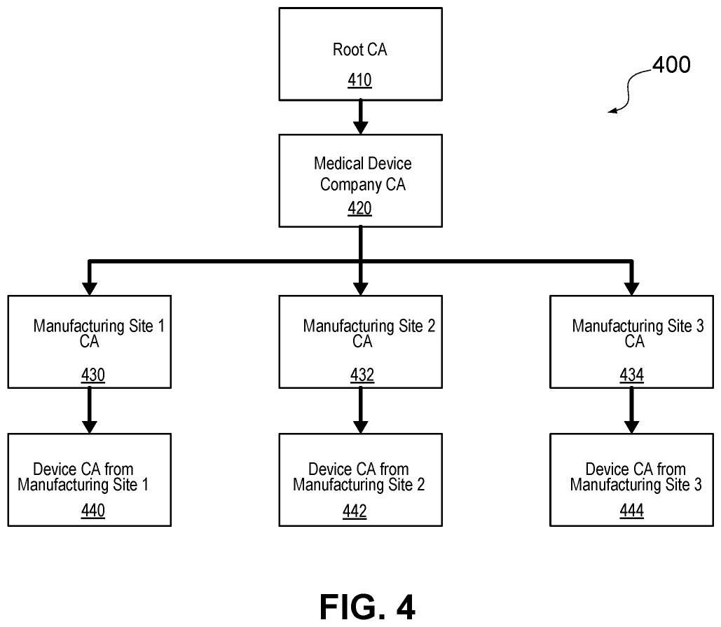

FIG. 3 shows an example of a system 300 including entities in a PKI according to certain embodiments. In the example of FIG. 3, the components responsible for providing the PKI include various trusted authorities. For example, the system 300 may include a CA 320 and a root CA 310. System 300 may also include other authorities 330, such as a registration authority (RA) 332. Authorities 320 and 330 are trusted entities whose responsibilities may include, among other things, issuing device certificates for electronic devices (e.g., a first electronic device 302 and a second electronic device 304) that participate in secured communications within system 300. Authorities 320 and 330 can be implemented in hardware, software, or a combination of hardware and software. As such, authorities 320 and 330 may correspond to logical entities that physically reside in a centralized location (e.g., a server computer) or are distributed across different computer systems. FIG. 3 is merely an example of one possible arrangement of authorities. Other configurations may feature additional or fewer authorities, and functionality described with respect to one type of authority may be combined with that of another authority.

Authorities 320 and 330 may be arranged in a trust hierarchy, with root CA 310 being the root of trust. Specifically, root CA 310 may have the highest level of trust in the PKI and may be issued (or self-generate) a root certificate 312 that has a comparatively long validity period. In some implementations, root certificate 312 may have no expiration date. Root CA 310 may own a private key that is used to instantiate a new certificate authority. Thus, root CA 310 may be solely responsible for issuing a CA certificate 322 for CA 320 and updating CA certificate 322 whenever CA certificate 322 needs to be renewed.

CA 320 may reside at the next level of the trust hierarchy, below the root CA 310. CA 320 may be responsible for issuing certificates to electronic devices as well as certificates for authorities residing at lower levels of the trust hierarchy (e.g., RA 332). In some instances, CA 320 may issue a certificate in response to a signature request. For example, an electronic device may send CA 320 a self-generated certificate, and CA 320 may issue the electronic device a device certificate corresponding to a signed version of the self-generated certificate. The device certificate would include a digital signature proving the authenticity of the device certificate, and therefore the identity of the bearer of the device certificate. In some embodiments, device certificates may be formatted in accordance with the X.509 certificate standard. Device certificates can be issued as part of enrolling electronic devices into the PKI of system 300. Electronic devices may also periodically request new device certificates (e.g., when an existing device certificate has expired or is about to expire). CA 320 may verify the identity of a device requesting a device certificate (e.g., by checking the contents of the self-generated certificate) as a condition for issuing the device certificate. CA 320 may also revoke device certificates in some circumstances (e.g., in response to a security breach that exposed an electronic device's private key).

The digital signature for a device certificate can be generated in various ways, such as through computing a hash of the self-generated certificate and encrypting the hash using a private key of CA 320. The hash can be computed using a standard hash algorithm, such as Secure Hash Algorithm 2 with 256 bits (SHA 256). The device certificate can be validated by decrypting the hash using a public key of CA 320, computing a hash of the device certificate as received by the entity performing the validation, and comparing the decrypted hash to the newly computed hash. The public key of CA 320 may be included in CA certificate 322. CA 320 may communicate CA certificate 322 to any entity that needs to validate device certificates, e.g., by sending the CA certificate to each electronic device enrolled in the PKI of in system 300. In this way, the electronic devices are able to authenticate each other by verifying that their device certificates are signed by CA 320, which is a mutually trusted authority.

RA 332 may be configured to sign renewal messages. At least some of the certificates generated and used in system 300 may be subject to periodic renewal (e.g., all certificates except the root certificate 312). Certificates to be renewed may include CA certificate 322, a certificate of RA 332 (not shown in FIG. 3), and device certificates (e.g., a device certificate 306). For example, root CA 310 may issue new CA certificates to CA 320, with RA 332 being responsible for distributing the new CA certificates. Similarly, CA 320 may issue new device certificates, and RA 332 may be responsible for distributing the new device certificates to electronic devices. CA 320 may also issue new RA certificates for self-distribution by RA 332. When an entity is issued a new certificate, the new certificate may include an updated public key that is paired with a corresponding updated private key. For example, an electronic device requesting a new device certificate may generate a new public-private key pair and include the public key in a signature request to CA 320.

CA certificates, device certificates, and other types of certificates used in system 300 may be distributed as update messages. Different entities may function as distributors for different types of certificates. In some embodiments, update messages are formatted as Public Key Cryptography Standards (PKCS) messages. For example, update messages may be PKCS#7 (RFC 2315) messages. The distributor of a certificate (e.g., the signer of a PKCS#7 message with a payload containing the certificate) is preferably different from the issuer of the certificate since this enhances security. For instance, a malicious user seeking to install an illegitimate device certificate on an electronic device may need to steal the private keys of both CA 320 and RA 332 (the issuer and the distributor, respectively, of device certificates in the above-described example).

The components in system 300 are communicatively intercoupled through one or more networks 350. Network(s) 350 may include wired and/or wireless networks that are accessed through a plurality of communications links, such as communication links 352, 353, 354, 355, and 356 (352-356). Communications links 352-356 may each be a wired connection and/or a wireless connection. Although not shown in FIG. 3, electronic devices 302 and 304 may also be communicatively coupled to each other through communications links. In embodiments where two devices are located in the same device housing, the communication links may include, for example, wires, cables, and/or communication buses on a printed circuit board, among other things. In embodiments where two devices are separated from each other in different device housings, the communication links may be wired and/or wireless connections.

Wired connections may include, without limitation, an Ethernet connection, a Universal Serial Bus (USB) connection, and/or another type of physical connection. Wireless connections may include, without limitation, a cellular connection, a Wi-Fi connection, a Bluetooth® connection, a mesh network connection, and/or another type of connection using a wireless communication protocol. Some communication links may use direct connections, such as Bluetooth® connections, and/or may use connections that route through one or more networks or network devices (not shown), such as an Ethernet network, a Wi-Fi network, a cellular network, a satellite network, an intranet, an extranet, the Internet, and/or the Internet backbone, among other types of networks. Various combinations of wired and/or wireless connections may be used for the above-described communication links.

As an illustrative example, electronic devices 302, 304 may establish a secure communication channel for communicating with each other using a Bluetooth® and/or near field communication (NFC) protocol. To establish the secure communication channel, electronic devices 302, 304 may engage in a pairing or bonding procedure in which the electronic devices exchange certain information, including information about one or more of the authorities (e.g., CA 320), and then validate the exchanged information. In some embodiments, the initial setup of the secure communication channel may involve exchanging device certificates and/or CA certificates. For example, electronic device 302 may include a device certificate 306 issued by CA 320. Further, electronic device 302 may include a CA certificate (not shown in FIG. 3) representing the identity of an authority (e.g., CA 320) that issued device certificate 306.

Device certificate 306 may be stored locally in a memory system of electronic device 302 and can be a digital certificate that was generated by electronic device 302 and then signed by CA 320 before being returned to electronic device 302. Device certificate 306 may include information identifying electronic device 302 (e.g., a device name, a hardware address, a network address, and/or other metadata) and a public key associated with electronic device 302. The public key may belong to a set of device security artifacts 308 maintained by electronic device 302. For example, device security artifacts 308 may further include a private key associated with electronic device 302. Electronic device 302 may use the private key to encrypt certain types of messages for transmission to electronic device 304 or some other recipient, and the messages may be decrypted using the public key.

Like electronic device 302, electronic device 304 may store its own device certificate and device security artifacts. The device certificate of electronic device 304 is typically issued by CA 320 at a different time than device certificate 306 of electronic device 302. This is because each electronic device 302 or 304 may be configured to independently request issuance of its corresponding device certificate. Further, electronic devices may be added to or removed (enrolled/unenrolled) from system 300 over time. For example, new electronic devices joining the system may be registered with RA 332 and issued device certificates at the time of registration. CA 320 may operate using CA certificate 322 that has an expiration period (e.g., several weeks, months, or years). CA 320 may use CA certificate 322 to digitally sign a device certificate, thereby attesting to the authenticity of the device certificate. In some examples, the electronic devices may store information about CA 320 and other authorities. For example, electronic device 302 may store authority information 305 that enables electronic device 302 to initiate an offline update of the CA certificate for an electronic device having an older CA certificate (e.g., electronic device 304).

The identities of electronic devices 302 and 304 (e.g., medical devices such as sensors and pumps) can be provisioned during the manufacturing, and the digital certificates of the electronic devices may be sent to a server to enroll the medical devices. An unenrolled electronic device may be treated as a counterfeit device and may not be able to access services provided by server, such as obtaining therapy firmware. When manufacturing a large quantity of devices (e.g., disposable medical devices), a manufacturer can provide unique identities to the devices using a hardware security module (HSM) in the manufacturing plant, or using Internet connections to another entity that generates and signs the identities for the devices. Using the HSM to store secure identities may be costly because the manufacturer may need to meet specific physical (and logical) security requirements, such as periodic audits, specific secure facilities and maintenance, and the like. Identity provisioning through Internet connections to another entity may have a lower cost, but may cause production line shutdown in the event of Internet connection failure, since the devices in the production line may not be able to obtain an identity from other entities to finalize the manufacturing process.

According to certain embodiments disclosed herein, the identity provisioning in the manufacturing process may be split into two or more separate operations performed at respective manufacturers without using HSMs or continuous Internet connections. A device may generate its own identity based on information received separately at two or more manufacturers. But neither manufacturer would be able to generate and provision unique identities to devices manufactured by the manufacturer. For example, a first manufacturer may install an activation firmware (an initial firmware) on an integrated circuit (e.g., a processor, a microcontroller unit, or a system-on-chip (SOC)), and then lock the integrated circuit so that the internal memory of the integrated circuit storing the activation firmware may not be read by another entity outside of the integrated circuit. The activation firmware may include a provisioning application and secrets (e.g., a key) to decrypt an encrypted provisioning message. But the first manufacturer may not have a provisioning message. A second manufacturer (e.g., a last manufacturer) of the device may receive an encrypted provisioning message, but may not be able to read the secrets from the device to decrypt the encrypted provisioning message and thus could not generate the identity. The second manufacturer may provide the provisioning message to the integrated circuit, which may execute the provisioning application to decrypt the encrypted provisioning message and generate the unique identity for the device using the provisioning message.

In one example, the devices may be disposable devices and may have an expected expiration date. An identity of an intermediate CA that may only be valid for a short period of time (rather than a long lasting CA) may be generated and provided to the second manufacturer in the form of an encrypted and signed provisioning message, so that a microcontroller unit (MCU) of a device may validate and decrypt the provisioning message to generate its own identity based on the identity of the intermediate CA. The first manufacturer may be a chip manufacturer that may only have access to an initial firmware including a bootloader for performing the provisioning operations and information for decrypting the provisioning message, but may not have access to the provisioning message. The information for decrypting the provisioning message may be a shared identity for provisioning. The first manufacturer may install the initial firmware on the MCU and lock the MCU so that the initial firmware would not be read back from the MCU by another entity. The second manufacturer may be a printed circuit board assembly (PCBA) manufacturer or device assembler. The second manufacturer may receive the encrypted provisioning message in advance from the device company and provide the encrypted provisioning message to the MCU (which is locked), so that the MCU can internally generate its own identity using the identity of the intermediate CA obtained from the provisioning message, and securely delete the shared identity for provisioning from its memory space. The second manufacturer may not have access to the initial firmware, and thus may not have access to information for decrypting the provisioning messages. The second manufacturer may store the digital certificates outputted by a batch of manufactured devices and send the stored digital certificates together to a device provider to enroll the devices.

In addition, for disposable devices that may have a short life time, it may be desirable to minimize the cost of bill of material and manufacturing processes. For example, the disposable device may have reduced hardware resource such as memory space and processing power. Therefore, the disposable device may not be able to hold two full images to perform a secure firmware update, and may not implement complex cryptographic algorithms. It may be desirable to development techniques that can use small memory and processing power to provision or update a therapy firmware at least once through firmware over-the-air (FOTA) in a secure manner to ensure that the medical device uses the most up-to-date firmware.

According to certain embodiments disclosed herein, during manufacturing, a device (e.g., a medical device) may be provided with a bootloader to support at least one full FOTA process, and a shared FOTA identity that can be used to decrypt a signed and encrypted firmware image received after the manufacturing. The device may be received by a user without a therapy firmware. A mobile device may be used for downloading (or pre-downloading and storing) the latest firmware for the type of device before the first use of the device. This may ensure that the firmware is the most up-to-date firmware (e.g., per FDA requirement). During pairing and initialization of the device with the mobile device in the field before the first use of the device, the encrypted therapy firmware is loaded onto the device via FOTA, and the bootloader may decrypt the encrypted therapy firmware images from the mobile device using the shared FOTA identity, install the therapy firmware, and erase the shared FOTA identity. Once the medical device is programmed with the therapy firmware and rebooted, the bootloader may be erased (e.g., replaced with history and traces), and the device may be activated with the therapy firmware launched, and may not be reprogrammed.

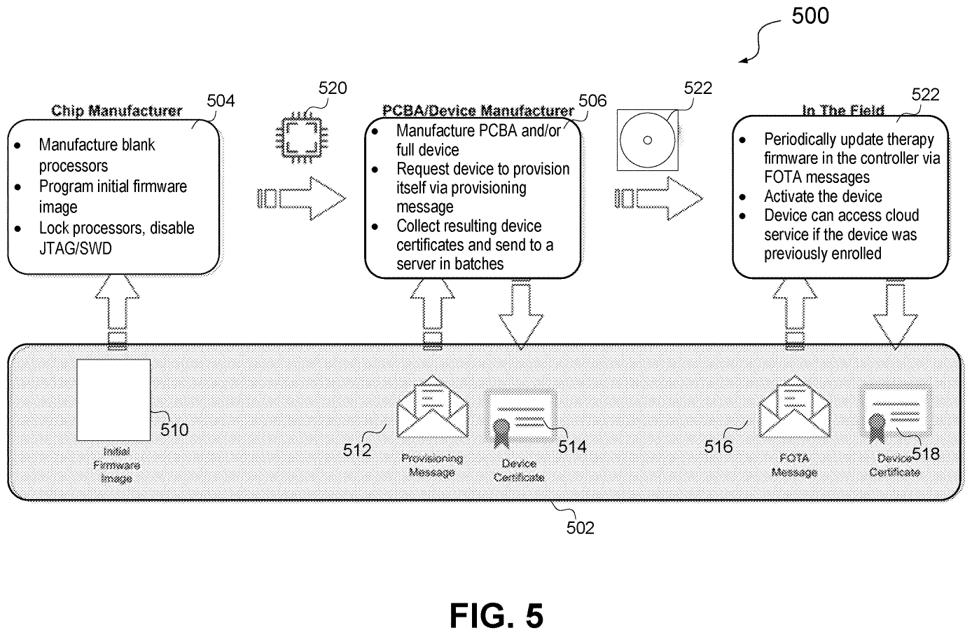

FIG. 4 illustrates an example of a PKI certificate hierarchy 400 that may be used to generate and manage the digital certificates for medical devices distributed by a medical device company. PKI certificate hierarchy 400 shows the chain of trust in a system, and may include a root CA 410, a certificate authority 420, a plurality of intermediate CAs 430, 432, and 434, and a plurality of device CAs 440, 442, and 444. Root CA 410 is the root of trust in the PKI and may issue authority certificates to certificate authorities 420. Root CA 410 may have the highest level of trust in the PKI and may have a long validity period. The private key of root CA 410 may be kept offline and physically protected. A certificate authority 420 may be the medical device company, which may issue certificates for the plurality of intermediate CAs 430, 432, and 434. In the illustrated example, the plurality of intermediate CAs 430, 432, and 434 may be associated with different respective manufacturing sites for manufacturing the medical devices. The digital certificates of intermediate CAs 430, 432, and 434 can be changed periodically, such as every month or every quarter. The private keys of intermediate CAs 430, 432, and 434 may be used to sign the digital certificates for device CAs 440, 442, and 444, and the certificates of intermediate CAs may also be saved to the corresponding medical devices such that a medical device may be traceable to the corresponding manufacturing site and production batch (e.g., date). The digital certificates for device CAs 440, 442, and 444 may also have a certain validity time, which may be determined based on the end-of-life (EOL) time of the medical devices. For example, for disposable medical devices with short EOL time, the digital certificates for device CAs 440, 442, and 444 may be valid for a limited time period, such as one or two years. The digital certificates of device CAs 440, 442, and 444 may be used to authenticate the medical devices and may be used for secure data communication and/or firmware update. In some examples, device CAs 440, 442, and 444 may be able to issue authority certificates to other devices or entities.

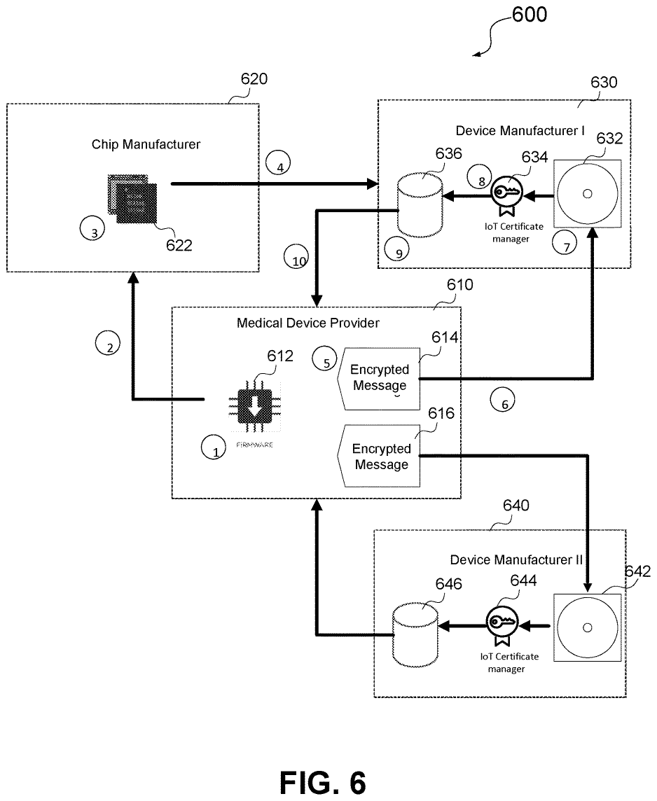

FIG. 5 illustrates an example of a flow 500 of identity provisioning and enrollment, and firmware provisioning for devices according to certain embodiments. In the illustrated example, a server 502 (e.g., a server of a device provider) or a plurality of servers 502 may store an initial firmware image 510. Initial firmware image 510 may include, for example, authority certificates, such as certificates of a root authority, a certificate authority, a registration authority, and/or a firmware authority. Initial firmware image 510 may also include a shared identity for provisioning, which may include a shared provisioning certificate and the private key associated with shared provisioning certificate as described above with respect to, for example, FIG. 2B. The shared identity for provisioning may be used to decrypt the payload of a provisioning request message. Initial firmware image 510 may also include a vector table pointing to a bootloader. The bootloader may function temporarily as an intermediate CA and may execute manufacturing and provisioning code (e.g., an App) in initial firmware image 510 to perform provisioning operations. In some examples, the bootloader may also support FOTA.

Server 502 may send initial firmware image 510 to a first manufacturer 504 (or a first manufacturing site), which may be a semiconductor chip manufacturer that may manufacture integrated circuits 520. An integrated circuit 520 may be a system-on-chip (SOC) device including a processor chip with integrated memory or coupled to a memory device. First manufacturer 504 may load initial firmware image 510 to a memory space of integrated circuit 520, such as a non-volatile memory device (e.g., a flash memory). Unused regions of the memory space may be filled with high entropy data (e.g., random data). First manufacturer 504 may then lock integrated circuit 520 so that the memory space of integrated circuit 520 (and thus at least the shared identity for provisioning) may not be read by an entity outside of integrated circuit 520. For example, integrated circuit 520 may be locked by disabling the Joint Test Action Group (JTAG) interface or Serial Wire Debug (SWD) interface. Integrated circuits 520 with the installed initial firmware image 510 may be sent to a second manufacturer 506 (or a second manufacturing site).

Second manufacturer 506 may be a printed circuit board assembly (PCBA) or device manufacturer. Second manufacturer 506 may install integrated circuits 520 on a PCBA and/or assemble a device 522. Second manufacturer 506 may also receive provisioning request messages 512 (or simply provisioning messages) for provisioning one or more devices from server 502 in advance, and may store the received provisioning request messages 512 at least temporarily, so that second manufacturer 506 may have provisioning request messages 512 to upload to integrated circuits 520 even if there is an interruption to the communication link between server 502 and second manufacturer 506.

A provisioning request message 512 may be signed by a certificate authority (e.g., certificate authority 220, 320, 420, or registration authority 230) for integrity and authenticity checks. The payload of provisioning request message 512 may be encrypted with at least the shared identity for provisioning. In some examples, the payload of provisioning request message 512 may be encrypted using the Elliptic Curve Integrated Encryption Scheme (ECIES) and the Elliptic Curve Diffie-Hellman (ECDH) key exchange algorithm. For example, the payload of provisioning request message 512 may include a hash index indicating a starting location for calculating a hash value of the memory space of integrated circuit 520, and may also include the identity of a manufacturer-specific intermediate CA (e.g., intermediate CA 430, 432, or 434) that is encrypted using the hash value and, for example, Advanced Encryption Standard (AES)-128 in Galois/Counter Mode (GCM) encryption. Because server 502 knows the expected content of the memory space of integrated circuit 520 loaded with the initial firmware image 510 (and high entropy data), server 502 is able to determine the correct hash value. In some examples, the payload of provisioning request message 512 may further include a shared identity for FOTA that may also be encrypted using the hash value and, for example, AES-128 GCM encryption. Thus, some portions of the payload of provisioning request message 512 may be double encrypted with, for example, the hash value and the private key of the shared identity for provisioning.

Second manufacturer 506 may power up integrated circuit 520 to perform some board level testing and/or device level testing. Integrated circuit 520 may receive messages (e.g., provisioning request messages or other manufacturing messages) from a manufacturing station, and may broadcast or advertise messages, such as identification information of integrated circuits 520. Upon receiving provisioning request message 512, integrated circuit 520 may run the bootloader to execute the manufacturing and provisioning code to provision the identity for device 522. For example, integrated circuit 520 may verify the integrity and authenticity of provisioning request message 512 that is signed by a certificate authority, using the public key of the certificate authority. Integrated circuit 520 may then decrypt the encrypted payload of provisioning request message 512 using the private key of the shared identity for provisioning to obtain the hash index and the portion of the payload encrypted with the hash value. The hash index may be a start attestation address that may be used by integrated circuit 520 to hash the internal memory space (e.g., flash memory) of integrated circuit 520. The hashing may start at the start attestation address, wrap from the end of the memory space to the beginning of the memory space, and end at the start attestation address, to determine a hash value. The determined hash value, if matching the hash value used by server 502 to encrypt the payload, may be used by integrated circuit 520 to decrypt the payload that was encrypted with the hash value. As described above, the decrypted payload may include the identity of the manufacturer-specific intermediate CA (e.g., intermediate CA 430, 432, or 434), which may include the private key and the digital certificate of the manufacturer-specific intermediate CA. In some examples, the decrypted payload may include a shared identity for FOTA, which may include the private key and the digital certificate of the shared identity for FOTA.

Integrated circuit 520 may then execute the manufacturing and provisioning code to generate a key pair and create a device certificate 514 that may include the public key of a device and the common name of the device (e.g., including device's serial number). The device certificate may be signed with the private key of the manufacturer-specific intermediate CA. Integrated circuit 520 may provision the device identity including the private key and the device certificate by storing the device identity in a reserved location in the memory space of integrated circuit 520. The authorities'certificates in the memory space may be updated to include the certificate of the manufacturer-specific intermediate CA and the associated private key. In some examples, the shared identity for provisioning may be replaced with the shared identity for FOTA, and thus integrated circuit 520 may no longer respond to manufacturing commands or additional provisioning request message to provision an identity for device 522. In some examples, the manufacturing and provisioning code for provisioning device identity may be overwritten with random data, so that the code capable of modifying the device identity is removed to minimize the risk of modifying the identity in the field.

In some examples, device certificates 514 of a plurality of devices 522 generated at second manufacturer 506 may be outputted by the plurality of devices 522 and temporarily stored at second manufacturer 506, and may be sent to server 502 in a batch. Server 502 may authenticate each device certificate 514 and, if successful, enroll the corresponding device 522. In some examples, the status of the enrollment may be provided to second manufacturer 506 using provisioning response messages. An enrolled device 522 may be able to communicate with other devices or entities in the same PKI. For example, an enrolled device 522 may be initialized and paired with a controller, such as a mobile device (e.g., computing device 106), and may obtain updated firmware from server 502 through the controller.

In the example shown in FIG. 5, when a user wants to use an enrolled device 522, the enrolled device 522 may use its identity to obtain a FOTA message 516 that includes a latest firmware from server 502 (which stores a corresponding device certificate 518 of enrolled device 522), directly or through a controller during initialization of device 522 (e.g., when device 522 is first paired with a controller) or periodically. For example, device 522 may request FOTA message 516 from a controller, which may obtain FOTA message from server 502 in advance or upon receiving the request from device 522. Similar to provisioning request message 512, FOTA message 516 may include a payload (e.g., a latest firmware image, such as a therapy firmware) encrypted using the shared identity for FOTA (e.g., the private key of the shared identity for FOTA), and may be signed by a certificate authority, such as certificate authority 220, 320, 420, or firmware authority 232). Upon receiving FOTA message 516, integrated circuit 520 in device 522 may execute the bootloader to install the latest firmware image. For example, device 522 may verify the signature (e.g., using a public key of the signing authority), decrypt FOTA message 516 using the shared identity for FOTA (e.g., the private key of the shared identity for FOTA) to obtain the latest firmware image in the payload of FOTA message 516, and verify the firmware version. Device 522 may then install the latest firmware image and erase the shared identity for FOTA.

After the latest firmware image is installed, integrated circuit 520 in device 522 may be rebooted to launch the firmware (e.g., a therapy firmware). In some examples, the memory space of integrated circuit 520 may be limited and may not be able to hold both the therapy firmware and the bootloader and other useful information, and thus the memory space used for the bootloader may be overwritten to store useful information such as history and traces. In some examples, the bootloader may be kept in the memory space and may be used for future firmware update. Device 522 may be ready to execute the therapy firmware to provide a therapy to the user. Because the therapy firmware is obtained and installed right before a device 522 is activated and device 522 may have a short use time (e.g., weeks), device 522 may always use the most up-to-date therapy firmware. More examples of the identity provisioning and firmware update are described in detail below.

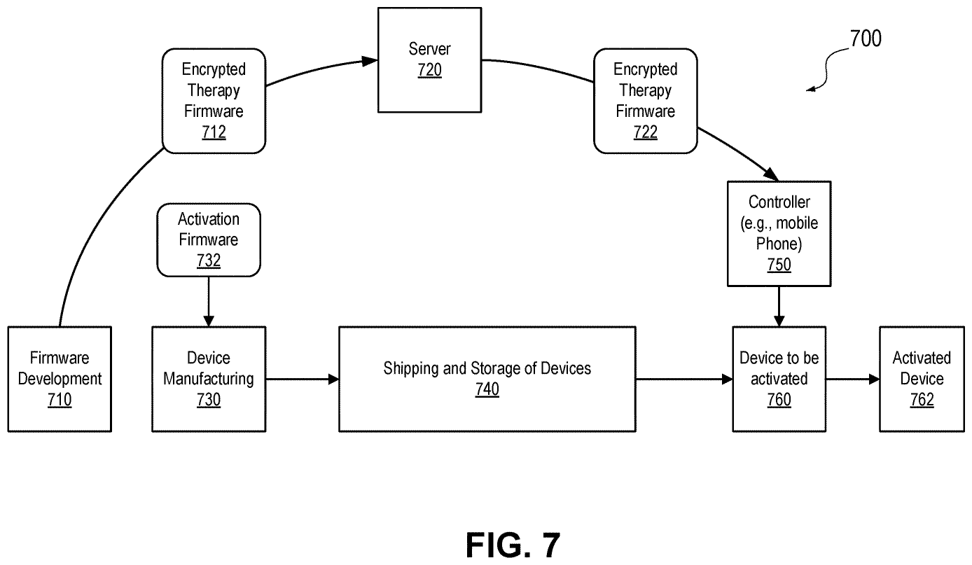

FIG. 6 illustrates an example of a process 600 of split-trust identity provisioning and enrollment for devices during device manufacturing according to certain embodiments. The process shown in FIG. 6 may be performed by a device provider 610, a chip manufacturer 620, a first device (or PCBA) manufacturer 630, and/or a second device manufacturer 640. Device provider 610 may provide an initial firmware image 612 (e.g., an activation image such as initial firmware image 510) to chip manufacturer 620 through secure file transfer, and may also provide an encrypted provisioning message 614 and an encrypted provisioning message 616 to first device manufacturer 630 and a second device manufacturer 640, respectively, through secure file transfer. Initial firmware image 612 includes an application for device identity provisioning and information for decrypt the encrypted provisioning message 614 or 616, such as a shared identity for provisioning. Encrypted provisioning messages 614 and 616 may include encrypted information for generating the device identity, such as the identity of a respective manufacturer-specific intermediate CA.

Chip manufacturer 620 may fabricate microcontroller units (MCUs) 622, load initial firmware image 612 onto MCUs 622, lock MCUs 622 to prevent other entities from reading the internal memory of MCUs 622, and send MCUs 622 loaded with initial firmware image 612 to first device manufacturer 630 and/a second device manufacturer 640. Since chip manufacturer 620 does not have encrypted provisioning message 614 or 616, it would not generate device identities even though it has the information for decrypting encrypted provisioning message 614 or 616.

First device manufacturer 630 or second device manufacturer 640 may install MCUs 622 on PCBAs and/or assemble devices 632 or 642, and may provide encrypted provisioning message 614 or 616 to MCUs 622. Since first device manufacturer 630 and second device manufacturer 640 may not have access to the internal memory of MCUs 622 and thus the shared identity for provisioning, first device manufacturer 630 and second device manufacturer 640 may not decrypt the received encrypted provisioning message 614 or 616 and thus may not generate device identities either. As such, neither chip manufacturer 620 or first device manufacturer 630 (or second device manufacturer 640) may be able to generate device identities on its own.

When powered up at first device manufacturer 630 or second device manufacturer 640, each MCU 622 may execute a bootloader in the initial firmware image to decrypt encrypted provisioning message 614 or 616 using the shared identity for provisioning to obtain the identity of the corresponding manufacturer-specific intermediate CA, use the identity of the corresponding manufacturer-specific intermediate CA to generate and sign a device identity for the assembled device 632 or 642, and store the device identity into the internal memory space of respective device 632 or 642. Therefore, device 632 or 642 may generate its own identity using MCU 622, initial firmware image 612, and encrypted provisioning message 614 or 616. As described above, the device identity may include a private key and a digital certificate signed by (e.g., the private key of) the corresponding manufacturer-specific intermediate CA, where the digital certificate may include a respective unique device serial number. As described above, the identity of a manufacturer-specific intermediate CA may be changed periodically, such as every month or every quarter. Device 632 or 642 with the device identity provisioned may output its digital certificate so that the device may be enrolled with device provider 610.

First device manufacturer 630 and/or second device manufacturer 640 may send the digital certificates outputted by the devices to device provider 610 to enroll the devices. For example, MCU 622 on a device 632 may output the digital certificate with the unique serial number of device 632 to a certificate manager 634, which may temporarily store the digital certificate with the unique serial number in a database 636 at first device manufacturer 630. First device manufacturer 630 may send the digital certificates for a batch of devices 632 to a server of device provider 610, such as an enterprise resource planning (ERP) database of device provider 610. Similarly, MCU 622 on a device 642 may output the digital certificate with the unique serial number of device 642 to a certificate manager 644, which may temporarily store the digital certificate with the unique serial number of device 642 in a database 646 at second device manufacturer 640. Second device manufacturer 640 may send the digital certificates for a batch of devices 642 to a server of device provider 610, such as the ERP database of device provider 610. The server of device provider 610 may authenticate each device certificate and, if successful, enroll the corresponding device. In some examples, the status of the enrollment may be provided to first device manufacturer 630 and/or second device manufacturer 640 using provisioning response messages.

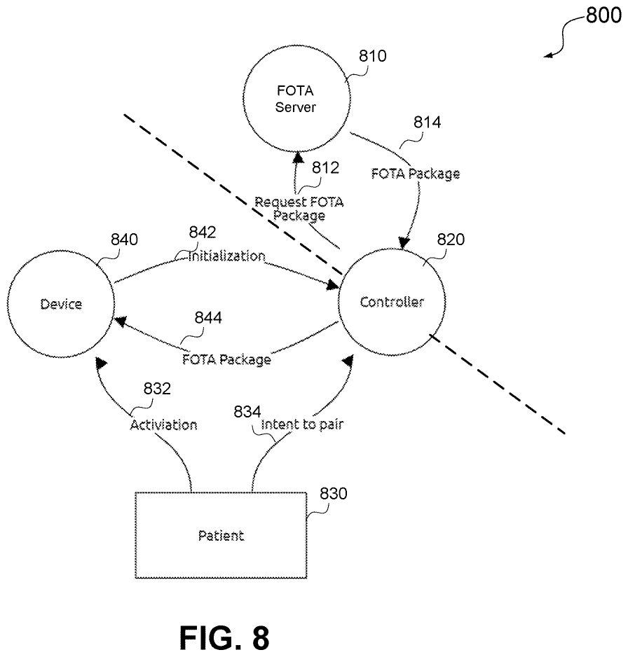

FIG. 7 illustrates an example of a process 700 of therapy firmware provisioning for a device according to certain embodiments. As illustrated, process 700 may include therapy firmware development at block 710, and secure transfer of an encrypted therapy firmware 712 to a server 720. Server 720 may store the therapy firmware so that the therapy firmware may be downloaded by devices or device controllers to install on the devices. At block 730, devices may be manufactured, and activation firmware 732 may be installed on the devices by one or more manufacturers, which may obtain activation firmware 732 from a device company that may distribute the device and/or provide services to users. As described above with respect to, for example, FIGS. 5 and 6, the devices may be fabricated by two or more manufacturers, which may include a MCU manufacturer and a PCBA/device assembler, and device identities of the devices may be provisioned using activation firmware 732. The devices with the installed activation firmware 732 and provisioned device identities may be shipped and/or stored by the device company, distributors or other third parties, and/or users at block 740.

A device controller 750 (e.g., a mobile device such as a smart phone) may obtain an encrypted therapy firmware 722 in advance or at a request of a device 760 that a user will start to use. The encrypted therapy firmware 722 may be a most up-to-date therapy firmware for device 760. Device controller 750 may send the encrypted therapy firmware 722 to device 760. At block 762, device 760 may execute the pre-installed activation firmware (e.g., a bootloader) to decrypt encrypted therapy firmware 722 and install the therapy firmware on device 760. Device 760 with the therapy firmware installed may be rebooted or otherwise activated, and can be used to perform the therapy based on the therapy firmware.

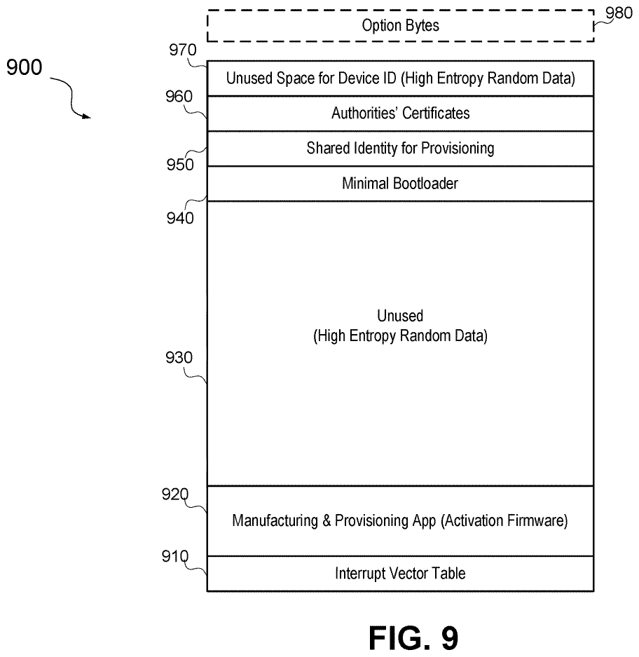

FIG. 8 illustrates an example of a process 800 of therapy firmware provisioning/update using FOTA according to certain embodiments. In the illustrated example, a FOTA server 810 may store the latest version of a therapy firmware for a type of device, such as a glucose sensor or an insulin pump. A controller 820 used by a patient 830 for controlling a device 840 may perform an operation 812 to query if a new therapy firmware is available, and may request the latest therapy firmware from FOTA server 810 if controller 820 does not have the latest therapy firmware. FOTA server 810 may perform an operation 814 to verify the controller 820 or patient 830, and send the latest therapy firmware in a FOTA package to controller 820 in a secure manner (e.g., by encrypting the FOTA package). Controller 812 may store the encrypted FOTA package so that it may transmit the FOTA package to device even if FOTA server 810 is unavailable or there is no network connection between FOTA server 810 and controller 820.

When a patient 830 needs to use a new device 840, patient 830 may perform an operation 832 to initiate the activation of device 840 (e.g., by turning on device 840 or inserting a medication reservoir into device 840), and may also perform an operation 834 to notify controller 820 the intent to pair device 840 with controller 820 (e.g., by activating a mobile app or a pairing process on controller 820). Device 840 may perform an operation 842 to initialization device 840, which may include broadcasting a signal (e.g., a BLE or NFC signal) for pairing, and requesting FOTA firmware from controller 820 after pairing with controller 820. Controller 820 may perform an operation 844 to transmit the stored encrypted FOTA package to device 840. Upon receiving the encrypted FOTA package, device 840 may execute a bootloader to decrypt the encrypted FOTA package using a shared identity for FOA, and install the therapy firmware on device 840. In some examples, after the installation of the therapy firmware, device 840 may reboot and start to execute the therapy firmware.

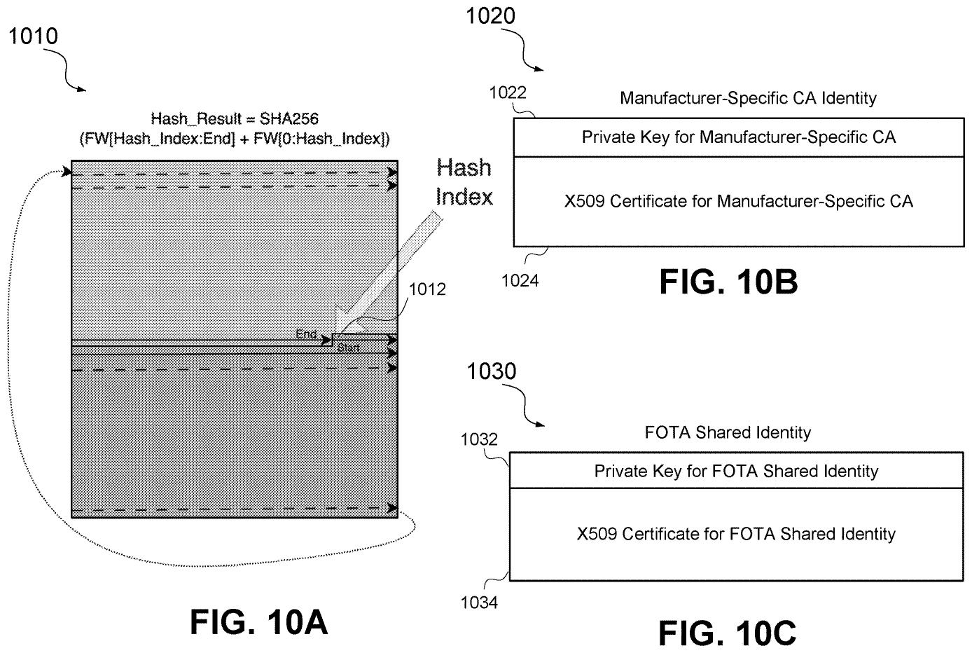

FIG. 9 illustrates an example of a memory space 900 of a device (e.g., in a microcontroller of the device) with an initial (activation) firmware image installed (e.g., by a first manufacturer such as a chip manufacturer) according to certain embodiments. The microcontroller of the device may be an example of integrated circuit 520 or MCU 622 described above and may not have been installed on a PCBA or assembled into a medical device yet, and thus may not have the device identity provisioned yet. The microcontroller with the initial firmware image installed may be locked so that memory space 900 of the microcontroller may not be read by an entity outside of the microcontroller.

In the illustrated example, the initial firmware image loaded into memory space 900 may include an interrupt vector table 910 that may include vectors pointing to a bootloader 940 to run bootloader 940 for provisioning operations if a device identity has not been provisioned. Bootloader 940 may be configured to implement, for example, the Bluetooth Low Energy (BLE) protocol stack, and parse commands or code such as firmware version identification commands, FOTA commands, manufacturing code, provisioning code, and the like. The initial firmware image in memory space 900 may also include an manufacturing and provisioning App 920 (e.g., an activation firmware) that may include code for manufacturing and provisioning functionality. Manufacturing and provisioning App 920 may be executed by bootloader 940 and may be replaced when no longer needed. The initial firmware image in memory space 900 may also include certificates 960 for authorities such as the root CA, a device company CA, a firmware authority, and the like. The initial firmware image in memory space 900 may further include a shared identity for provisioning 950, which may include a private key for decrypting encrypted provisioning messages and a digital certificate of the shared identity for provisioning. Memory space 900 may include an unused space 970 that may be reserved for storing a device identity to be provisioned. Unused space 970 and another unused space 930 may be loaded with high entropy data (e.g., random data) to allow attestation. In some examples, memory space 900 may store some option bytes 980 (or equivalent) that may be used to make sure the processor is locked once programmed and debugging ports are not functional.

As described above, in order to provision the device identity, a device (more specifically, the microcontroller of the device, such as integrated circuit 520 or MCU 622) with the initial firmware image installed as shown in FIG. 9 may use a provisioning request message from a certificate authority (e.g., certificate authority 220, 320, or 420). The provisioning request message may be signed by the certificate authority and may be encrypted using the shared identity for provisioning. For example, the provisioning request message may include a header and a payload encrypted by the shared identity for provisioning. The payload may include a start attestation address (e.g., a starting address for hashing), and an identity of an intermediate CA (e.g., an intermediate CA 430, 432, or 434 for a PCBA/device manufacturer) that may be encrypted using a hash value. In some examples, the payload may also include a shared identity for FOTA.

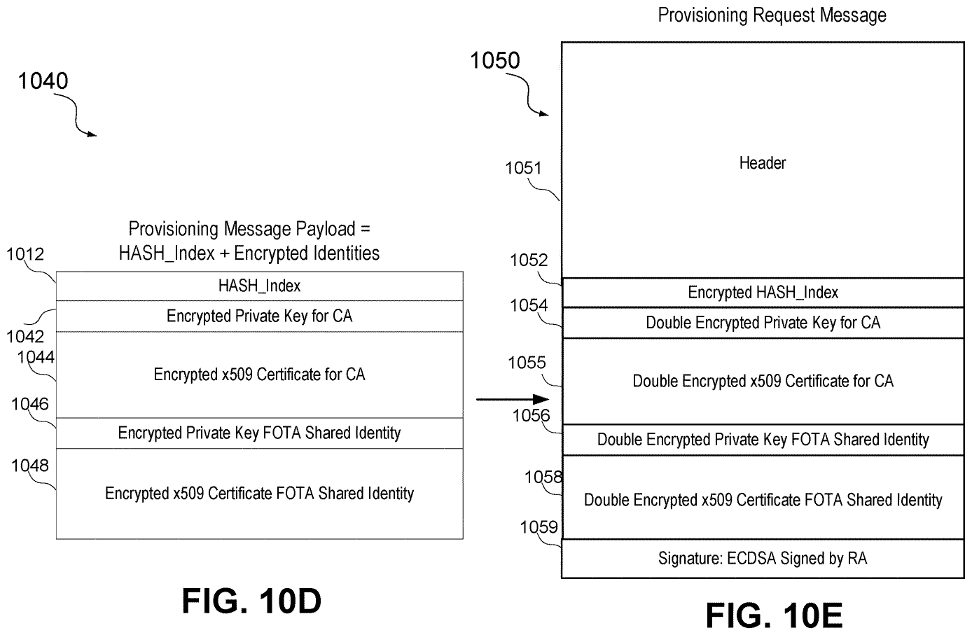

FIGS. 10A-10E illustrate an example of a process of generating a provisioning request message (or simply a provisioning message) for identity provisioning according to certain embodiments. FIG. 10A illustrates an example of a hash operation 1010. In hash operation 1010, a random hash index 1012, from which the hash begins, may be generated for every provisioning request message. The hash may start at the address of a memory space (or an image file) corresponding to hash index 1012, wrap from the end of the memory space (or the image file) to the beginning of the memory space, and end at the start attestation address, to determine a hash value that may be used to encrypt the payload of the provisioning request message. In one example, the hashing algorithm may be Secure Hash Algorithm 256 (SHA-256) that transforms data into a 256-bit hash value.

FIG. 10B shows that an example of a manufacturer-specific CA identity 1020 may be generated. Manufacturer-specific CA identity 1020 may include a private key 1022 and a digital certificate 1024 as described above with respect to, for example, FIG. 2B. In one example, digital certificate 1024 may be an X.509 certificate signed by a certificate authority (e.g., certificate authority 220, 320, or 420) to establish a chain of trust. Each manufacturer may have its own identity so that every provisioned device can be traced to a specific manufacturer and, in case of a leak, the origin of the leak can be identified and remedial action can be taken accordingly. Manufacturer-specific CA identity 1020 may be changed frequently (e.g., monthly or quarterly) to improve security.

FIG. 10C shows that an example of a shared identity for FOTA 1030 may be generated. Shared identity for FOTA 1030 may include a private key 1032 and a digital certificate 1034 as described above with respect to, for example, FIG. 2B. In one example, digital certificate 1034 may be an X.509 certificate. Each type of product/device may use its own shared identity for FOTA. The shared identity for FOTA 1030 may specify the type of product to be used for the common name (e.g., common name 272) in the device's unique identity, and protect the confidentiality of the therapy firmware image while the therapy firmware image is transferred from a server to a device in the field. The shared identity for FOTA 1030 may also be used to enforce the allowed versions of firmware and prevent therapy firmware images created for other types of devices from being installed on the device.

FIG. 10D shows an example of a payload 1040 of a provisioning request message. Payload 1040 may include the random hash index 1012 used in hash operation 1010, and manufacturer-specific CA identity 1020 shown in FIG. 10B and shared identity for FOTA 1030 shown in FIG. 10C (if used) that are encrypted using the hash value determined by hash operation 1010 using a symmetric encryption technique, such as AES-128 in Galois/Counter Mode (GCM) encryption. In the illustrated example, payload 1040 may include an encrypted private key 1042 for manufacturer-specific CA identity 1020, an encrypted digital certificate 1044 for manufacturer-specific CA identity 1020, an encrypted private key 1046 for shared identity for FOTA 1030, and an encrypted digital certificate 1048 for shared identity for FOTA 1030. In some examples, payload 1040 may include a minimum firmware version allowed for FOTA, and the device model configuration to be applied to the device at the time of FOTA.

To decrypt payload 1040, a recipient of the provisioning request message would determine the correct hash value by performing a hash operation on the content of the memory space of the microcontroller with the initial firmware image installed, based on the random hash index 1012. Thus, if the memory space of the microcontroller has been modified after the initial firmware image is installed, a correct hash value would not be generated, and payload 1040 would not be correctly decrypted. As such, the encryption using the hash value may ensure that the microcontroller is locked and the memory space of the microcontroller loaded with the initial firmware image is not modified by a chip manufacturer, during the transit from the chip manufacturer to the PCBA/device manufacturer, or by the PCBA/device manufacturer before the device identity provisioning.

FIG. 10E shows an example of a provisioning request message 1050 that may be generated by encrypting payload 1040 shown in FIG. 10D using, for example, Elliptic Curve Integrated Encryption Scheme (ECIES). Provisioning request message 1050 may include a header 1051, an encrypted payload, and a signature 1059 that may be signed by a registration authority, such as registration authority 230. The encrypted payload may include payload 1040 encrypted using, for example, the private or public key of the shared identity for provisioning 950. Therefore, some portions of the payload of provisioning request message 1050 may be double-encrypted using the shared identity for provisioning 950 and the hash value determined in hash operation 1010. In the illustrated example, the payload may include an encrypted hash index 1052, a double-encrypted private key 1054 for manufacturer-specific CA identity 1020, a double-encrypted digital certificate 1055 for manufacturer-specific CA identity 1020, a double-encrypted private key 1056 for shared identity for FOTA 1030, and a double-encrypted digital certificate 1058 for shared identity for FOTA 1030. Header 1051 may be used to accommodate security needs while minimizing computing resources. Signature 1059 may be used to check the integrity of the message and authenticate the sender. In some examples, signature 1059 may be calculated using the Elliptic Curve Digital Signature Algorithm (ECDSA) along with SHA-256 hashes, and both header 1051 and the encrypted payload.

The provisioning request message 1050 may be sent by the device provider to the PCBA/device manufacturer, which may assemble the PCBA or device, perform some board level testing and device level testing, and send provisioning request message 1050 to the microcontroller of the device. Upon receiving the provisioning request message 1050, the microcontroller may perform attestation and provisioning by executing bootloader 940 and/or manufacturing and provisioning app 920. The attestation may include, for example, (1) verifying provisioning request message 1050 with the public key of the certificate authority (e.g., in certificates 960 for authorities); (2) decrypting the encrypted payload of provisioning request message 1050 using the private key of the shared identity for provisioning 950 to obtain hash index 1012 (the start attestation address) and the portions of payload 1040 that is (e.g., AES) encrypted using the hash value; (3) hashing the entire memory space of the microcontroller from the start attestation address (wrapping to the beginning at the end of memory space) to generate a hash value; and (4) decrypting the AES encrypted portions of payload 1040 to obtain the manufacturer-specific CA identity 1020 and/or shared identity for FOTA 1030. The provisioning may include generating a device certificate key pair, creating a device certificate that may include the device's serial number in the common name and may be signed with the private key associated with manufacturer-specific CA identity 1020, and storing the device identity in a reserved region (e.g., unused space 970) in memory space 900 of the microcontroller.

After the successful provisioning of the device identity, the private key associated with manufacturer-specific CA identity 1020 may be deleted, and certificates 960 for authorities may be updated to include the digital certificate of manufacturer-specific CA identity 1020. In some examples, the microcontroller may replace the shared identity for provisioning 950 with the shared identity for FOTA 1030 that is included in payload 1040. In some examples, manufacturing and provisioning app 920 may be erased so that the microcontroller may no longer support manufacturing commands or new provisioning request messages.

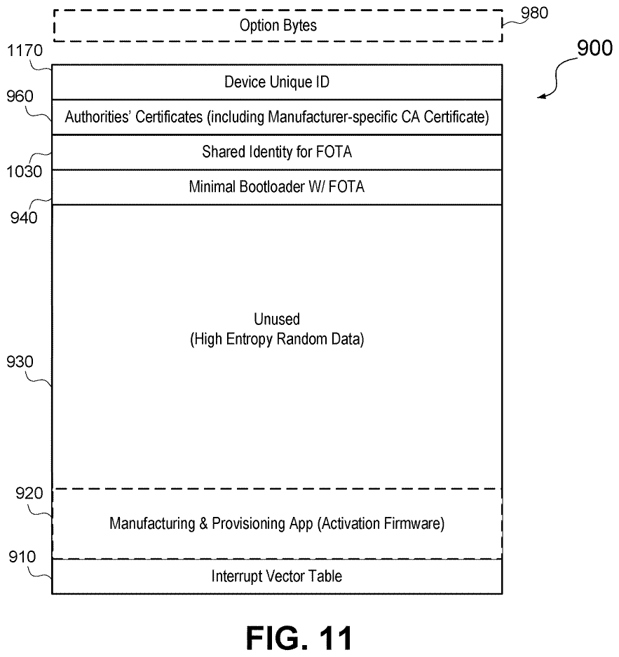

FIG. 11 illustrates an example of memory space 900 of the device of FIG. 9 with a device identity provisioned according to certain embodiments. As illustrated, after the successful provisioning of the device identity, memory space 900 may store interrupt vector table 910, manufacturing and provisioning App 920 (optional), high entropy data in unused space 930, and bootloader 940. Other regions of memory space 900 may be modified. For example, shared identity for provisioning 950 may be replaced with shared identity for FOTA 1030, unused space 970 may now store a unique device identity 1170, and certificates 960 for authorities may be updated to also include the certificate of manufacturer-specific CA identity 1020. As described above, in some embodiments, manufacturing and provisioning App 920 may be overwritten with random data, so that the provisioned device identity may no longer be modified after leaving the PCBA/device manufacturer's facility.

In addition, after the successful provisioning of the device identity, the microcontroller may output the digital certificate of the device identity to a device certificate database of the PCBA/device manufacturer. The PCBA/device manufacturer may send the digital certificates of a batch of devices to a server (e.g., an enrollment server) of the certificate authority (e.g., the device provider). The server may authenticate the digital certificates and, if successful, enroll the devices. The server may optionally provide the status of the enrollment to the PCBA/device manufacturer. The devices may be shipped to and stored at distributors or users of the devices. At this point, the devices may not have a therapy firmware installed. The therapy firmware may be installed on a device over the air when a user will start to use the device as described above with respect to, for example, FIGS. 7 and 8.

For example, when a user wants to activate and use the device, the device may be activated to request and receive the latest therapy firmware through a controller (e.g., controller 820). The latest therapy firmware may be in a FOTA package encrypted using the shared identity for FOTA 1030. The bootloader in the memory space of the microcontroller may verify the signature of the FOTA package and the firmware version, decrypt the therapy firmware using the shared identity for FOTA 1030, install the therapy firmware, and erase the shared identity for FOTA 1030.

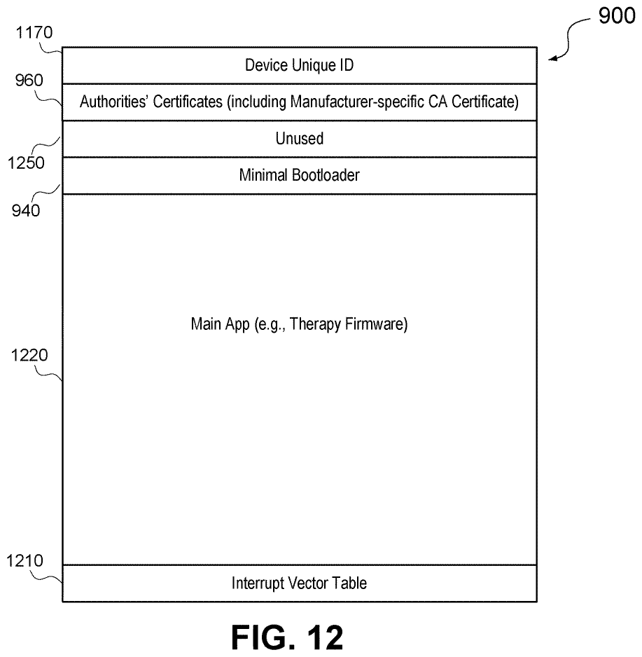

FIG. 12 illustrates an example of memory space 900 of a device with a therapy firmware provisioned through FOTA according to certain embodiments. As illustrated, after the successful provisioning of the device identity, memory space 900 may store an interrupt vector table 1210 for executing the therapy firmware, a main app 1220 (e.g., a therapy firmware), bootloader 940 (optional), certificates 960 for authorities (including the certificate of manufacturer-specific CA identity 1020), and unique device identity 1170. A region 1250 in memory space 900 that is previously used for storing the shared identity for FOTA 1030 may be erased and reused later for data storage.

After the therapy firmware is installed, the microcontroller may be rebooted, the memory space used for storing the bootloader may be erased and used for storing other data (e.g., history and trace), and therapy firmware may be launched to start the medical therapy.

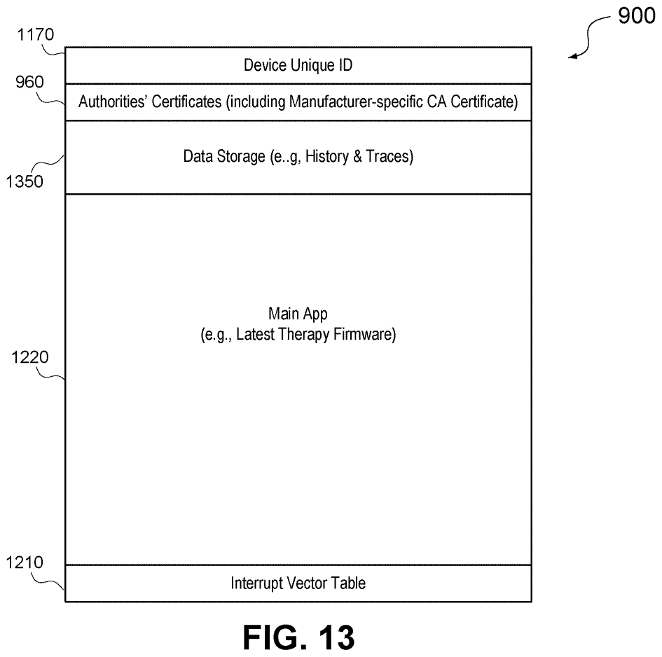

FIG. 13 illustrates an example of memory space 900 of the device after therapy firmware initialization according to certain embodiments. As illustrated, after the reboot of the device, memory space 900 may store interrupt vector table 1210 for executing the therapy firmware, main app 1220 (e.g., a therapy firmware), certificates 960 for authorities (including the certificate of manufacturer-specific CA identity 1020), and unique device identity 1170. A region 1350 in memory space 900 that is previously used for storing the shared identity for FOTA 1030 and the bootloader may be used for data storage (e.g., storing device history and traces).

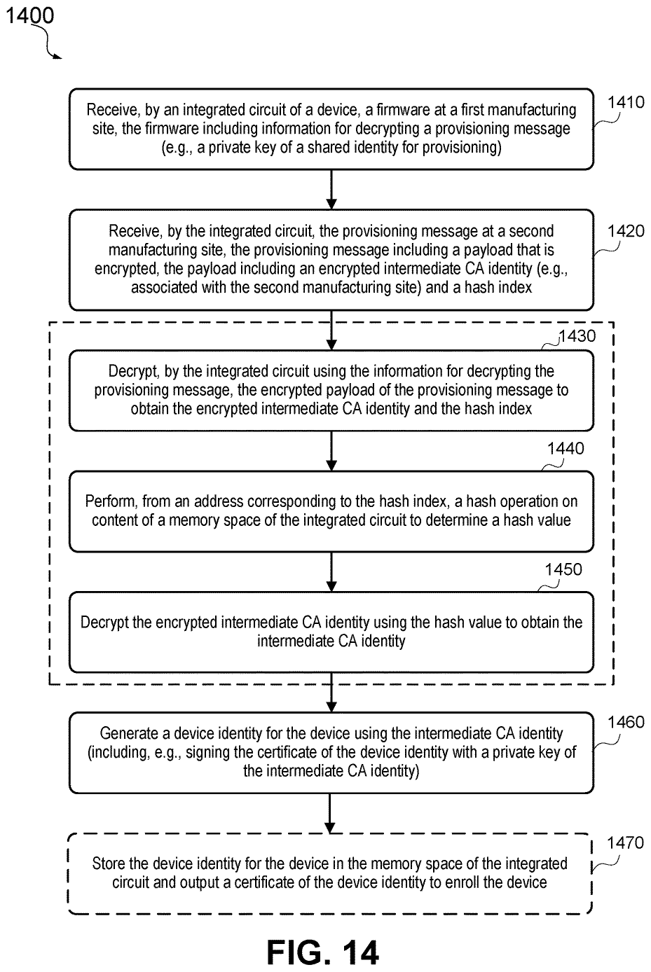

FIG. 14 includes a flowchart 1400 illustrating an example of a method of device identity provisioning during a manufacturing process according to certain embodiments. Operations in flowchart 1400 may be performed by an integrated circuit of the device, such as a processing unit, a control circuit, a microcontroller, an ASIC, an SOC, an FPGA, and the like, in a physiological sensor (e.g., a glucose sensor) or an infusion pump (e.g., an insulin pump). The integrated circuit may include non-volatile memory (e.g., flash memory) for storing software, firmware, identities, certificates, keys, code, and other data. It is noted that the operations illustrated in FIG. 14 provide particular processes for device identity provisioning. Other sequences of operations can also be performed according to alternative examples. For example, alternative examples may perform the operations in a different order. Moreover, the individual operations illustrated in FIG. 14 can include multiple sub-operations that can be performed in various sequences as appropriate for the individual operation. Furthermore, some operations can be added or removed depending on the particular examples. In some examples, two or more operations may be performed in parallel. One of ordinary skill in the art would recognize many variations, modifications, and alternatives.

Operations at block 1410 of flowchart 1400 may include receiving, by an integrated circuit of a device, a firmware at a first manufacturing site, the first firmware including information for decrypting a provisioning message. The device may include, for example, a disposable physiological sensor, a non-disposable physiological sensor, a disposable infusion pump, or a non-disposable infusion pump, such as a manual insulin pen device or an automatic closed-loop insulin pump. In some examples, the firmware may include a provisioning application, such as a bootloader or manufacturing and provisioning code, as shown in, for example, FIG. 9. In some examples, the firmware may include a shared identity for provisioning, and the information for decrypting the provisioning message may include a private key of the shared identity for provisioning. In some examples, the firmware may include a certificate of at least one of a root authority, a certificate authority, a registration authority, or a firmware authority. The integrated circuit may include a memory space for storing the firmware. In some examples, unused memory space of the integrated circuit with the firmware loaded may include high entropy data such as random data. In some examples, the firmware in the memory space may include one or more option bytes to ensure that the integrated circuit is locked. In some examples, the firmware may include a bootloader for FOTA. The integrated circuit may be locked before leaving the first manufacturing site to prevent reading the memory space from outside of the integrated circuit.

Operations at block 1420 may include receiving, by the integrated circuit, the provisioning message at a second manufacturing site. The provisioning message may be generated as described with respect to, for example, FIGS. 10A-10E, and may include a payload that is encrypted as shown in, for example, FIG. 10E. The payload may include an encrypted intermediate CA identity. In some examples, the payload may include a hash index. The intermediate CA identity in the payload may be encrypted using a hash value determined based on the hash index. The intermediate CA identity may be associated with the second manufacturing site and may have an expiration date (e.g., a month or a few months). In some examples, the payload of the provisioning message may include a shared identity for firmware over-the-air (FOTA), which may be encrypted. The provisioning message may be signed by a certificate authority or a registration authority. In some examples, the provisioning message may be verified with a public key of the certificate authority. The encrypted payload of the provisioning message may then be decrypted using the information for decrypting the provisioning message to obtain the intermediate CA identity, for example, as described below with respect to blocks 1430, 1440, and 1450.

Operations at block 1430 may include decrypting, by the integrated circuit using the information for decrypting the provisioning message, the encrypted payload of the provisioning message to obtain the encrypted intermediate CA identity and the hash index. For example, the payload of the provisioning message may have been encrypted using the public key of the shared identity for provisional and the Elliptic Curve Integrated Encryption Scheme (ECIES), and the integrated circuit may execute the provisioning application to decrypt the encrypted payload of the provisioning message using the private key of the shared identity for provisioning. In one example, the decrypted payload may be similar to payload 1040 shown in FIG. 10D.

Operations at block 1440 may include performing, from an address corresponding to the hash index, a hash operation on content of a memory space of the integrated circuit to determine a hash value. As described above with respect to, for example, FIG. 10A, the hash operation may start at the address of the memory space corresponding to the hash index, wrap from the end of the memory space to the beginning of the memory space, and end at the start attestation address, to determine the hash value. In one example, the hashing algorithm may be Secure Hash Algorithm 256 (SHA-256) that transforms data into a 256-bit hash value.

Operations at block 1450 may include decrypt the encrypted intermediate CA identity using the hash value to obtain the intermediate CA identity as described above with respect to, for example, FIGS. 5, 6, and 10D. In one example, the intermediate CA identity may be encrypted using the hash value and AES-128 GCM, and the encrypted intermediate CA identity may be decrypted using the hash value and AES-128 GCM. An example of the decrypted intermediate CA identity is shown in FIG. 10B.

In some examples where the payload of the provisioning message includes a shared identity for FOTA and the firmware includes a bootloader for FOTA, decrypting the encrypted payload of the provisioning message may also include decrypting the encrypted shared identity for FOTA to obtain the shared identity for FOTA (e.g., as shown in FIG. 10C), in the operations of blocks 1430-1450. At the second manufacturing site, the information for decrypting the provisioning message in a memory space of the integrated circuit may be replaced with the shared identity for FOTA.

Operations at block 1460 may include generating a device identity for the device using the intermediate CA identity (e.g., signing the certificate of the device identity with a private key of the intermediate CA identity). Generating the device identity for the device using the intermediate CA identity may include generating a private key and a public key for the device identity, generating a certificate including the public key and a serial number for the device, and signing the certificate using a private key of the intermediate CA identity.

Operations at block 1470 may include storing the device identity for the device in the memory space of the integrated circuit, and outputting a certificate of the device identity for enrolling the device with a server. In some examples, after generating the device identity for the device, the provisioning application may be deleted from the integrated circuit. In some examples, a certificate of the intermediate CA identity may be stored in the non-volatile memory space, and a private key of the intermediate CA identity may be deleted from the integrated circuit.

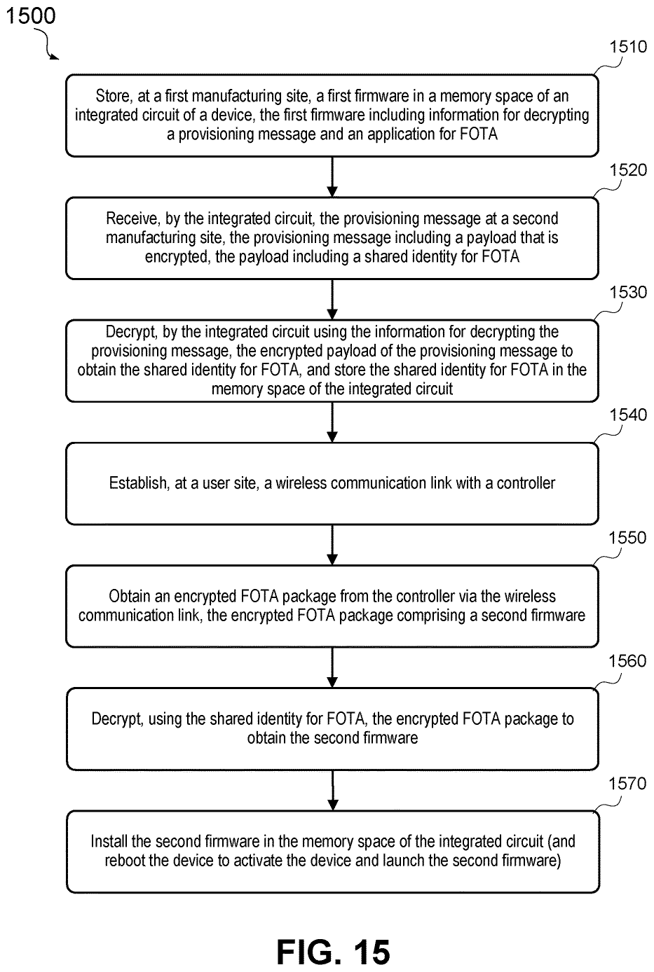

FIG. 15 includes a flowchart 1500 illustrating an example of a method of firmware provisioning according to certain embodiments. Operations in flowchart 1500 may be performed by an integrated circuit of the device, such as a processing unit, a control circuit, a microcontroller, an ASIC, an SOC, an FPGA, and the like, in a physiological sensor (e.g., a glucose sensor) or an infusion pump (e.g., an insulin pump). The integrated circuit may include non-volatile memory (e.g., flash memory) for storing software, firmware, identities, certificates, keys, code, and other data. It is noted that the operations illustrated in FIG. 15 provide particular processes for device identity provisioning. Other sequences of operations can also be performed according to alternative examples. For example, alternative examples may perform the operations in a different order. Moreover, the individual operations illustrated in FIG. 15 can include multiple sub-operations that can be performed in various sequences as appropriate for the individual operation. Furthermore, some operations can be added or removed depending on the particular examples. In some examples, two or more operations may be performed in parallel. One of ordinary skill in the art would recognize many variations, modifications, and alternatives.

Operations at block 1510 of flowchart 1500 may include storing, at a first manufacturing site, a first firmware in the integrated circuit (e.g., a microcontroller), as described above with respect to, for example, FIGS. 5-7 and 9. The first firmware may include information for decrypting a provisioning message and an application for firmware over-the-air (FOTA). For example, as shown in FIG. 9 described above, the first firmware may include a shared identity for provisioning 950, and the information for decrypting the provisioning message may include a private key of the shared identity for provisioning. In some examples, the first firmware may include an application for device identity provisioning, such as manufacturing and provisioning App 920 and/or bootloader 940. The first firmware may also include other fields, such as a certificate of at least one of a root authority, a certificate authority, a registration authority, or a firmware authority. As described above, the integrated circuit may be locked before leaving the first manufacturing site, to prevent reading a memory space of the integrated circuit from outside of the integrated circuit.

Operations at block 1520 may include receiving, by the integrated circuit, the provisioning message at a second manufacturing site, the provisioning message including a payload that is encrypted, the payload including a shared identity for FOTA. In some examples, the payload includes a hash index, and the shared identity for FOTA in the payload is encrypted using a hash value determined based on the hash index. In some examples, the payload of the provisioning message includes an intermediate CA identity, the intermediate CA identity in the payload is encrypted using the hash value. The intermediate CA identity may be associated with the second manufacturing site and may have an expiration date (e.g., a month or a few months). The intermediate CA identity may be used to generate the identity for the device (e.g., signing the certificate of the device identity with a private key of the intermediate CA identity).

Operations at block 1530 may include decrypting, by the integrated circuit using the information for decrypting the provisioning message, the encrypted payload of the provisioning message to obtain the shared identity for FOTA, and store the shared identity for FOTA in the memory space of the integrated circuit. In some examples, decrypting the encrypted payload of the provisioning message may include decrypting the encrypted payload of the provisioning message using the information for decrypting the provisioning message to obtain the hash index and the encrypted shared identity for FOTA, performing a hash operation on content of a memory space of the integrated circuit from an address corresponding to the hash index to determine a hash value, and decrypting the encrypted shared identity for FOTA using the hash value to obtain the shared identity for FOTA. In some examples, at the second manufacturing site, the information for decrypting the provisioning message in a memory space of the integrated circuit may be replaced with the shared identity for FOTA. In some examples, decrypting the encrypted payload of the provisioning message may include decrypting the encrypted payload of the provisioning message to obtain the encrypted intermediate CA identity, and decrypting the encrypted intermediate CA identity using the hash value to obtain the intermediate CA identity. A device identity for the device may be generated using the intermediate CA identity as described above with respect to, for example, FIG. 14. The digital certificate of the device may be sent to a server to enroll the device. An enrolled device may be able to access services provided by a device provider, such as obtaining new or updated firmware from the device provider.

Operations at block 1540 may include establishing a wireless communication link (e.g., a BLE link) with a controller (e.g., a smartphone or a tablet) as described above with respect to, for example, FIGS. 7 and 8. Operations at block 1540 may be performed at a user's site when, for example, the user is ready to activate and use the device. The wireless communication link may use various wireless communication protocols, such as Bluetooth, WiMax, or Wi-Fi, NFC, and the like. In some examples, the wireless communication link may be established by broadcasting a signal for pairing by the device when powered on or instructed by a user. In some examples, the wireless communication link may be established by detecting a nearby controller by the device based on a signal broadcast by the controller.

Operations at block 1550 may include obtaining an encrypted FOTA package from the controller via the wireless communication link, the encrypted FOTA package comprising a second firmware, such as a therapy firmware, as described above with respect to, for example, FIGS. 7 and 8. The controller may or may not have Internet access at the time of establishing the wireless communication link with the device. In some examples, the controller may have downloaded the second firmware from a server (e.g., server 502, server 720, or FOTA server 810) and stored the second firmware locally in advance. In some examples, the controller may, upon receiving a request from the device, obtain the second firmware for the device from the sever using the identity of the device (e.g., the digital certificate of the device, the common name or serial number, and/or other information used to enroll the device). The FOTA package may be encrypted using, for example, ECIES and the shared identity for FOTA (e.g., the public key of the shared identity for FOTA).

Operations at block 1560 may include decrypting, using the shared identity for FOTA, the encrypted FOTA package to obtain the second firmware. For example, the shared identity for FOTA may include a private key and a digital certificate, and decrypting the encrypted FOTA package may include decrypting the encrypted FOTA package using ECIES and the shared identity for FOTA (e.g., the private key of the shared identity for FOTA). After decrypting the encrypted FOTA package, the shared identity for FOTA may be deleted from the memory space of the integrated circuit. In some examples, the signature and firmware version of the decrypted firmware may be verified before installing the firmware.

Operations at block 1570 may include installing the second firmware in the memory space of the integrated circuit, and rebooting the device to activate the device and launch the second firmware, as described above with respect to, for example, FIGS. 5, 7, 8, 12, and 13. In one example, the content of the memory space of the device after the installation of the second firmware (e.g., a therapy firmware) may be shown by FIG. 12, and the content of the memory space of the device after the rebooting may be shown by FIG. 13. In some examples, the application for installing the firmware on the integrated circuit using FOTA (e.g., bootloader 940) may be erased after the rebooting, and the memory space used by the application for installing the firmware may be used to store data such as history and traces as shown in FIG. 13.

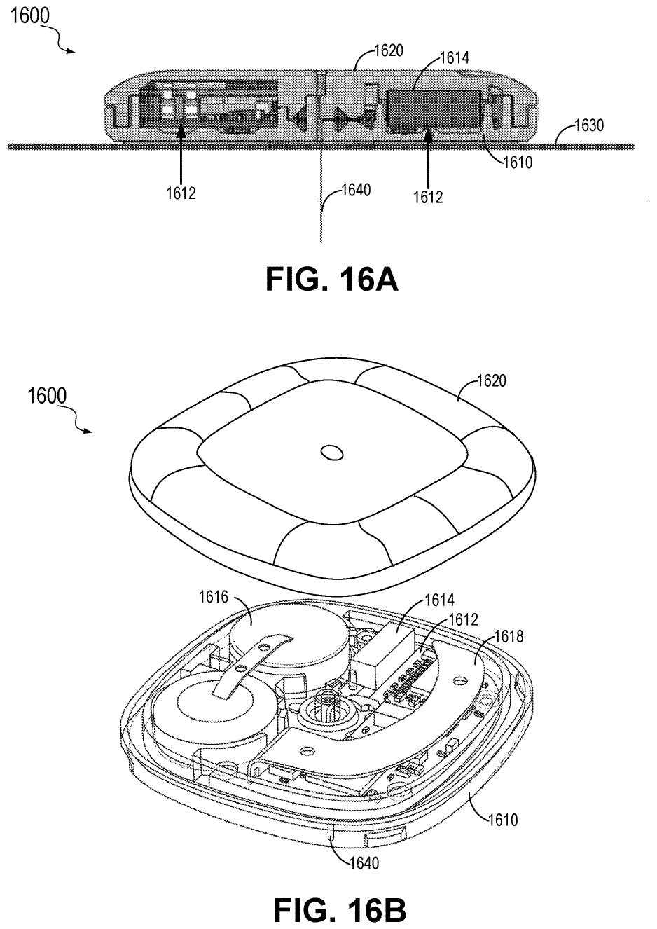

FIGS. 16A and 16B depict an example of an integrated glucose sensor device 1600 according to certain embodiments, which may implement some of the examples disclosed herein. Glucose sensor device 1600 may be an example of monitoring device 104. In the illustrated example, glucose sensor device 1600 may include a housing formed by a base 1610 and a top cover 1620, sensor electronics enclosed in the housing, an electrochemical sensor 1640 partially within the housing and connected to the sensor electronics, and an adhesive patch 1630 attached to base 1610. Electrochemical sensor 1640 may be an example of the electrochemical sensors described above, and may include multiple electrodes at a distal end that may be inserted into the subcutaneous layer of a user. A proximal end of electrochemical sensor 1640 may be bent and held against a printed circuit board (PCB) 1612 by a elastomer or rubber block 1614, such that contacts on the proximal end of electrochemical sensor 1640 may be physically and electrically connected to contact pads on PCB 1612. The housing may be hermetically sealed to protect the sensor electronics from moisture. Electrochemical sensor 1640 may be inserted into the subcutaneous layer of the user using an inserter. The inserter may include a needle and may enclose the entire glucose sensor device 1600 before insertion. When activated (e.g., pushed), the inserter may move the entire glucose sensor device 1600 toward the skin of the user to attach adhesive patch 1630 to the skin of the user and insert the distal end of electrochemical sensor 1640 into the subcutaneous layer of the user using the needle, where the needle may be retracted, for example, automatically after the distal end of electrochemical sensor 1640 is inserted into the user.

The sensor electronics in the housing may include batteries 1616, an antenna 1618, and circuits on PCB 1612. The circuits on PCB 1612 may include, for example, a processor, a controller, a potentiostat, filters, amplifiers, a wireless (e.g., Bluetooth) transceiver, one or more memory devices, power conversion and management devices, or a combination thereof. Predicted in vivo characteristics of electrochemical sensor 1640 and SG model(s) described above may be stored in the one or more memory devices. Before or after the distal end of electrochemical sensor 1640 is inserted into the subcutaneous layer of the user, the sensor electronics may be activated to initialize the sensor for measuring sensor measurement data (e.g., Isig, Vcntr, EIS, etc.). The processor or controller may execute instruction code stored on the one or more memory device to obtain the sensor measurement data, process (e.g., filter, amplify, transform, etc.) the sensor measurement data, estimate SG values using the SG models and sensor measurement data, optionally blank certain estimated SG values, and transmit, via the wireless transceiver and antenna 1618, the estimated SG values to a receiver (e.g., a smartphone or an insulin pump), as described above.

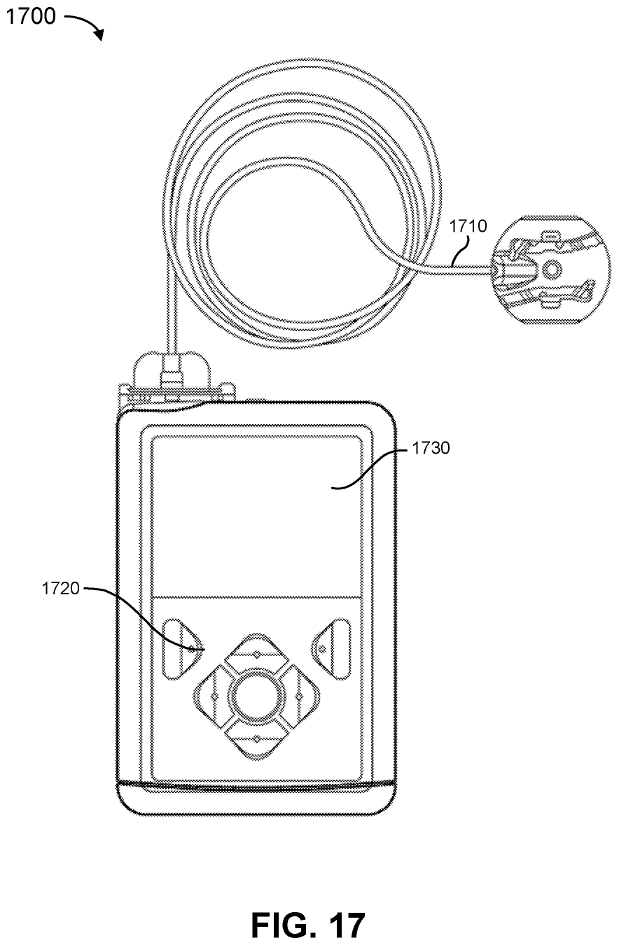

FIG. 17 depicts an example of a delivery device 1700, which may implement a delivery device described above (e.g., delivery device 102). In an insulin delivery device implemented using delivery device 1700, insulin delivery may be performed based on internal communication between a central computing module (e.g., a microprocessor of delivery device 1700) and an insulin delivery module (e.g., including a microcontroller, a motor, and a pump). For instance, insulin delivery may be caused by the central computing module communicating a delivery command in the form of an electrical signal that travels via a communication fabric to the insulin delivery module. The central computing module may also be configured to communicate (e.g., via a transceiver) with a computing device (e.g., computing device 106 of FIG. 1) communicatively coupled to a remote or cloud computing system (e.g., remote/cloud computing system 108 of FIG. 1). Delivery device 1700 may communicate various event data toward the remote or cloud computing system, which may communicate insulin delivery determinations toward delivery device 1700, in accordance with the techniques described herein.

Delivery device 1700 may provide insulin through a small tube 1710 configured for fluidic connection with a cannula inserted subcutaneously. Delivery device 1700 may be configured to deliver two types of dosages—a basal dosage, which can be delivered periodically (e.g., every five minutes) in tiny amounts throughout the day and night, and a bolus dosage to cover an increase in blood glucose from meals and/or to correct high blood glucose levels. In the depicted example, delivery device 1700 includes a user interface having button elements 1720 that can be manipulated to administer a bolus of insulin, to change therapy settings, to change user preferences, to select display features, and the like. Delivery device 1700 may also include a display device 1730 that can be used to present various types of information or data to the user. In accordance with aspects of the present disclosure, a user of delivery device 1700 may use button elements 1720 to input certain event data (e.g., event type, event start time, event details, etc.), and the user inputs can be confirmed using display device 1730. Delivery device 1700 of FIG. 17 is merely provided by way of example, and other types of insulin delivery devices and other techniques different from those described above are contemplated to be within the scope of the present disclosure.

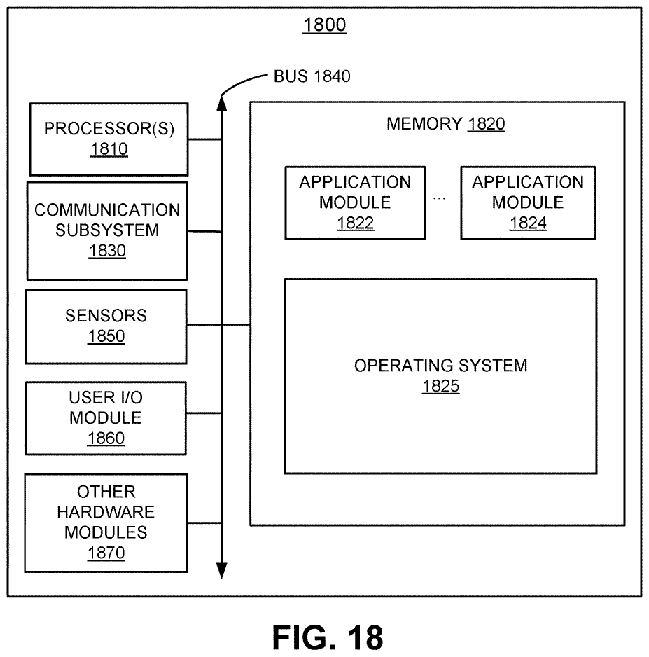

FIG. 18 is a block diagram of an example of an electronic device 1800 that may implement some of the examples disclosed herein. For example, electronic device 1800 may be used to implement delivery device 102, monitoring device 104, computing device 106, and remote/cloud computing system 108, device 522, device 632, device 642, device 760, or device 840, or another medical or computing device. In the illustrated example, electronic device 1800 may include one or more processor(s) 1810 and memory 1820. Processor(s) 1810 may be configured to execute instructions stored in memory 1820 for performing one or more of the methods described herein and other applications. Processor(s) 1810 may include, for example, one or more central processing units, microprocessors, microcontrollers, special-purpose processors (e.g., digital signal processors), ASICs, DSPs, FPGAs, or other processors suitable for implementation within a portable electronic device. Processor(s) 1810 may be communicatively coupled with a plurality of components within electronic device 1800. To realize this communicative coupling, processor(s) 1810 may communicate with the other illustrated components across a bus 1840. Bus 1840 may be any subsystem adapted to transfer data within electronic device 1800. Bus 1840 may include a plurality of computer buses and additional circuitry to transfer data.

Memory 1820 may include one or more transitory and/or non-transitory storage devices, such as, for example, a static random access memory (SRAM), a dynamic random access memory (DRAM), a read-access memory (RAM), a read-only memory (ROM), a programmable read-only memory (PROM), an erasable programmable read-only memory (EPROM), a FLASH-EPROM, a secure digital (SD) card, and any other memory chip or cartridge. Such storage devices may be configured to implement any appropriate data stores, including without limitation, various file systems, data structures, computer-readable instructions, program modules, and the like. In some embodiments, memory 1820 may be distributed into different hardware modules.

Memory 1820 may include an operating system 1825 loaded therein. Operating system 1825 may be operable to initiate the execution of the instructions provided by application modules 1822-1824 and/or manage other hardware modules 1870, as well as interface with a communication subsystem 1830 which may include one or more wired and/or wireless transceivers. Operating system 1825 may be adapted to perform other operations across the components of electronic device 1800 including threading, virtualization, resource management, data storage control, and other similar functionality. In some embodiments, memory 1820 may store a plurality of application modules 1822 through 1824, which may include any number of applications. Examples of the applications may include an insulin calculator, a blood glucose level monitor or predictor, a glucose level management application, and the like. Application modules 1822-1824 may include particular instructions to be executed by processor(s) 1810. In some embodiments, certain applications or parts of application modules 1822-1824 may be executable by other hardware modules 1870.

Communication subsystem 1830 may include, for example, an infrared communication device, a wireless communication device and/or chipset (such as a Bluetooth® device, an IEEE 802.11 device, a Wi-Fi device, a WiMax device, cellular communication devices, etc.), and/or similar communication interfaces. One or more antennas (not shown) may be used for wireless communication as part of communication subsystem 1830 or as a separate component coupled to any portion of electronic device 1800, such as a wireless charging receiver or a near-field communication receiver. In some embodiments, communication subsystem 1830 may include circuits for wired communication technologies, such as Ethernet, coaxial communications, universal serial bus (USB), and the like. Communications subsystem 1830 may permit data to be exchanged with a network, other computer systems, and/or any other devices. For example, communications subsystem 1830 may be used to receive therapy determinations for therapeutic fluid (e.g., insulin) delivery, such as from a cloud computing system via an intermediary computing device (e.g., a controller) communicatively coupled to electronic device 1800, where processor(s) 1810 may, based on the therapy determinations, send commands to an actuator controller to cause the delivery of appropriate amounts of therapeutic fluid (e.g., insulin) to a user. In another example, communications subsystem 1830 may be used to communicate measurement results (e.g., sensor glucose levels) to a computing device (e.g., a smartphone or a personal health monitoring device) and/or to a remote server via the computing device, or receive data (e.g., calibration data, configuration data, etc.) from the computing device or the remote server via the computing device.

Sensor(s) 1850 may include, for example, a camera, an infrared sensor, an accelerometer, a pressure sensor, a temperature sensor, a proximity sensor, a magnetometer, a gyroscope, an inertial sensor (e.g., an inertial measurement unit (IMU)), an ambient light sensor, a position sensor, a depth sensor, a gesture detector, or any other similar module operable to provide sensory output and/or receive sensory input. In one example, one or more sensors of the electronic device 1800 may be configured to measure a physiological parameter. For example, sensor(s) 1850 may include an interstitial or blood glucose sensor.

Input/output user interface 1860 may allow a user to send action requests to electronic device 1800 to perform particular actions, and may provide information (e.g., status of electronic device 1800, measurement results, alerts, etc.) to the user. Input/output user interface 1860 may include one or more input devices, such as, for example, a touchscreen, a touch pad, microphone(s), button(s), dial(s), switch(es), a keyboard, a mouse, a game controller, or any other suitable device for receiving action requests and communicating the received action requests to processor(s) 1810. In some embodiments, input/output user interface 1860 may include one or more output devices, such as a display, a speaker, a light emitting device, a haptic device, and the like, to provide feedback to or alert the user.

In some embodiments, electronic device 1800 may include a plurality of other hardware modules 1870. Each of other hardware modules 1870 may be a physical module within electronic device 1800. While each of other hardware modules 1870 may be permanently configured as a structure, some of other hardware modules 1870 may be temporarily configured to perform specific functions or temporarily activated. Examples of other hardware modules 1870 may include, for example, an audio output and/or input module (e.g., a microphone or speaker), a near field communication (NFC) module, a rechargeable battery, a battery management system, a wired/wireless battery charging system, an actuator controller, and the like. In some embodiments, one or more functions of other hardware modules 1870 may be implemented in software.

In one example, electronic device 1800 may be part of an insulin delivery device (e.g., a pump) that can deliver fast-acting insulin through a small tube configured for fluidic connection with a cannula inserted subcutaneously. Electronic device 1800 may cause the delivery of two types of dosages—a basal dosage, which can be delivered periodically (e.g., every five minutes) in tiny amounts throughout the day and night, and a bolus dosage to cover an increase in blood glucose from meals and/or to correct high blood glucose levels. The insulin delivery device may include a user interface having button elements that can be manipulated to administer a bolus of insulin, to change therapy settings, to change user preferences, to select display features, and the like, The insulin delivery device may also include a display device that can be used to present various types of information or data to the user. In accordance with aspects of the present disclosure, a user of the insulin delivery device may use the button elements to input certain event data (e.g., event type, event start time, event details, etc.), and the user inputs can be confirmed using the display device.

In various implementations, the above-described hardware and modules may be implemented on a single device or on multiple devices that can communicate with one another using wired or wireless connections. In alternative configurations, different and/or additional components may be included in electronic device 1800. Similarly, functionality of one or more of the components can be distributed among the components in a manner different from the manner described above.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to like elements throughout the description of the figures.

Any of the herein described techniques, operations, methods, programs, algorithms, or codes may be converted to, or expressed in, a programming language or computer program embodied on a computer, processor, or machine-readable medium. The terms “programming language” and “computer program,” as used herein, each include any language used to specify instructions to a computer or processor, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. To the extent consistent, any or all of the aspects detailed herein may be used in conjunction with any or all of the other aspects detailed herein. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure. While several embodiments of the disclosure have been depicted in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto. The aspects and features of the present disclosure and may be embodied in various forms. Thus, specific structural and functional details disclosed herein are not to be interpreted as limiting, but as a basis for the claims and as a representative basis for teaching one skilled in the art to variously employ the present disclosure in virtually any appropriately detailed structure.

With reference to the appended figures, components that can include memory can include non-transitory machine-readable media. The term “machine-readable medium,” “processor-readable medium,” or “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, etc.

Also, in this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

In view of this description embodiments may include different combinations of features. Implementation examples are described in the following numbered clauses:
Clause 1. A method comprising, by an integrated circuit of a device:
   receiving, at a first manufacturing site, a firmware comprising information for decrypting a provisioning message;
   receiving the provisioning message at a second manufacturing site, the provisioning message comprising a payload that is encrypted, the payload including an intermediate certificate authority (CA) identity;
   decrypting, using the information for decrypting the provisioning message, the encrypted payload of the provisioning message to obtain the intermediate CA identity; and
   generating a device identity for the device using the intermediate CA identity.
Clause 2. The method of clause 1, wherein:
   the payload includes a hash index;
   the intermediate CA identity in the payload is encrypted using a hash value determined based on the hash index; and
   decrypting the encrypted payload of the provisioning message comprises:
      decrypting the encrypted payload of the provisioning message to obtain the hash index and the encrypted intermediate CA identity;
      performing, from an address corresponding to the hash index, a hash operation on content of a memory space of the integrated circuit to determine the hash value; and
      decrypting the encrypted intermediate CA identity using the hash value to obtain the intermediate CA identity.
Clause 3. The method of clause 1 or 2, wherein:
   the firmware comprises a provisioning application; and
   the integrated circuit is configured to execute the provisioning application to decrypt the encrypted payload of the provisioning message and generate the device identity for the device.
Clause 4. The method of clause 3, further comprising, after generating the device identity for the device, deleting the provisioning application from the integrated circuit.
Clause 5. The method of any of clauses 1-4, wherein:
   the firmware includes a shared identity for provisioning; and
   the information for decrypting the provisioning message includes a private key of the shared identity for provisioning.
Clause 6. The method of any of clauses 1-5, wherein the intermediate CA identity is associated with the second manufacturing site and has an expiration date.
Clause 7. The method of any of clauses 1-6, wherein generating the device identity for the device using the intermediate CA identity comprises:
   generating a private key and a public key for the device identity;
   generating a certificate including the public key and a serial number for the device; and
   signing the certificate using a private key of the intermediate CA identity.
Clause 8. The method of any of clauses 1-7, wherein:
   the integrated circuit includes a memory space for storing the firmware; and
   the integrated circuit is locked before being transferred to the second manufacturing site to prevent reading the memory space from outside of the integrated circuit.
Clause 9. The method of clause 8, wherein the firmware in the memory space includes one or more option bytes to ensure that the integrated circuit is locked.
Clause 10. The method of any of clauses 1-9, further comprising:
   storing the device identity in a non-volatile memory space of the integrated circuit;
   storing a certificate of the intermediate CA identity in the non-volatile memory space; and
   deleting a private key of the intermediate CA identity from the integrated circuit.
Clause 11. The method of any of clauses 1-10, further comprising outputting a certificate of the device identity for enrolling the device with a server.
Clause 12. The method of any of clauses 1-11, wherein the firmware includes a certificate of at least one of a root authority, a certificate authority, a registration authority, or a firmware authority.
Clause 13. The method of clause 12, further comprising verifying the provisioning message with a public key of the certificate authority.
Clause 14. The method of clause 12 or 13, wherein the provisioning message is signed by the certificate authority or the registration authority.
Clause 15. The method of any of clauses 1-14, wherein:
   the payload of the provisioning message includes a shared identity for firmware over-the-air (FOTA); and
   the firmware includes a bootloader for FOTA.
Clause 16. The method of any of clauses 1-15, wherein:
   the shared identity for FOTA in the payload of the provisioning message is encrypted; and
   decrypting the encrypted payload of the provisioning message includes decrypting the encrypted shared identity for FOTA to obtain the shared identity for FOTA.
Clause 17. The method of clause 16, further comprising replacing, at the second manufacturing site, the information for decrypting the provisioning message in a memory space of the integrated circuit with the shared identity for FOTA.
Clause 18. The method of clause 17, further comprising, at a user site:
   receiving, wirelessly from a controller device, an encrypted FOTA package including a therapy firmware;
   decrypting the encrypted FOTA package using the shared identity for FOTA;
   install the therapy firmware in the memory space of the integrated circuit; and removing the shared identity for FOTA from the memory space of the integrated circuit.
Clause 19. The method of clause 18, further comprising:
   rebooting the integrated circuit;
   erasing the bootloader for FOTA; and
   executing the therapy firmware.
Clause 20. The method of any of clauses 1-19, further comprising filling unused memory space of the integrated circuit with high entropy data at the first manufacturing site.
Clause 21. The method of any of clauses 1-20, wherein the device includes a disposable physiological sensor or a disposable infusion pump.
Clause 22. A method comprising:
   providing a firmware to a first manufacturing site to install the firmware on a controller of a device, the firmware comprising a provisioning application and information for decrypting a provisioning message; and
   sending the provisioning message to a second manufacturing site to provide the provisioning message to the controller, the provisioning message including a payload that is encrypted, the payload including an intermediate certificate authority (CA) identity,
   wherein the provisioning application, when executed by the controller, causes the controller to perform operations comprising, at the second manufacturing site:
      decrypting, using the information for decrypting the provisioning message, the encrypted payload of the provisioning message to obtain the intermediate CA identity; and
      generating a device identity for the device using the intermediate CA identity.
Clause 23. The method of clause 22, wherein:
   the payload includes a hash index;
   the intermediate CA identity in the payload is encrypted using a hash value determined based on the hash index; and
   decrypting the encrypted payload of the provisioning message comprises:
      decrypting the encrypted payload of the provisioning message to obtain the hash index and the encrypted intermediate CA identity;
      performing, from an address corresponding to the hash index, a hash operation on content of a memory space of an integrated circuit of the device to determine the hash value; and
      decrypting the encrypted intermediate CA identity using the hash value to obtain the intermediate CA identity.
Clause 24. The method of clause 22 or 23, wherein:
   the firmware includes a shared identity for provisioning; and
   the information for decrypting the provisioning message includes a private key of the shared identity for provisioning.
Clause 25. The method of any of clauses 22-24, wherein generating the device identity for the device using the intermediate CA identity comprises:
   generating a private key and a public key for the device identity;
   generating a certificate including the public key and a serial number for the device; and
   signing the certificate using a private key of the intermediate CA identity.
Clause 26. A method of installing a firmware on a device, the method comprising, by an integrated circuit of the device:
   at one or more manufacturing sites,
      storing, in a memory space of the integrated circuit, an application for installing the firmware on the integrated circuit using firmware over-the-air (FOTA); and
      storing a shared identity for FOTA in the memory space; and
   at a user site, executing the application to perform operations comprising:
      establishing a wireless communication link with a controller;
      obtaining an encrypted FOTA package from the controller via the wireless communication link, the encrypted FOTA package comprising the firmware;
      decrypting, using the shared identity for FOTA, the encrypted FOTA package to obtain the firmware; and
      installing the firmware in the memory space of the integrated circuit.
Clause 27. The method of clause 26, further comprising, after decrypting the encrypted FOTA package, removing the shared identity for FOTA from the memory space of the integrated circuit.
Clause 28. The method of clause 26 or 27, wherein:
   the shared identity for FOTA includes a private key and a digital certificate; and
   decrypting the encrypted FOTA package includes decrypting the encrypted FOTA package using the private key of the shared identity for FOTA.
Clause 29. The method of any of clauses 26-28, further comprising:
   receiving, at a first manufacturing site of the one or more manufacturing sites, an initial firmware image comprising the application and information for decrypting a provisioning message;
   receiving the provisioning message at a second manufacturing site of the one or more manufacturing sites, the provisioning message comprising a payload that is encrypted, the payload including the shared identity for FOTA; and
   decrypting, using the information for decrypting the provisioning message, the encrypted payload of the provisioning message to obtain the shared identity for FOTA.
Clause 30. The method of clause 29, wherein:
   the initial firmware image includes a shared identity for provisioning; and
   the information for decrypting the provisioning message includes a private key of the shared identity for provisioning.
Clause 31. The method of clause 29 or 30, further comprising replacing, at the second manufacturing site, the information for decrypting the provisioning message in the memory space of the integrated circuit with the shared identity for FOTA.
Clause 32. The method of any of clauses 29-31, wherein:
   the payload includes a hash index;
   the shared identity for FOTA in the payload is encrypted using a hash value determined based on the hash index; and
   decrypting the encrypted payload of the provisioning message comprises:
      decrypting the encrypted payload of the provisioning message to obtain the hash index and the encrypted shared identity for FOTA;
      performing, from an address corresponding to the hash index, a hash operation on content of the memory space of the integrated circuit to determine the hash value; and
      decrypting the encrypted shared identity for FOTA using the hash value to obtain the shared identity for FOTA.
Clause 33. The method of clause 32, wherein:
   the initial firmware image includes provisioning code;
   the payload of the provisioning message includes an intermediate certificate authority (CA) identity, the intermediate CA identity in the payload is encrypted using the hash value;
   decrypting the encrypted payload of the provisioning message comprises:
      decrypting the encrypted payload of the provisioning message to obtain the encrypted intermediate CA identity; and
      decrypting the encrypted intermediate CA identity using the hash value to obtain the intermediate CA identity; and
   the method further comprises generating a device identity for the device using the intermediate CA identity.
Clause 34. The method of clause 33, wherein generating the device identity for the device includes:
   generating a private key and a public key for the device identity;
   generating a certificate including the public key and a serial number for the device; and
   signing the certificate using a private key of the intermediate CA identity.
Clause 35. The method of clause 33 or 34, further comprising:
   storing the device identity in a non-volatile memory space of the integrated circuit;
   storing a certificate of the intermediate CA identity in the non-volatile memory space; and
   deleting a private key of the intermediate CA identity from the integrated circuit.
Clause 36. The method of any of clauses 29-35, wherein the integrated circuit is locked before being transferred to the second manufacturing site to prevent reading the initial firmware image from outside of the integrated circuit.
Clause 37. The method of any of clauses 26-36, further comprising:
   rebooting the integrated circuit;
   erasing the application for installing the firmware on the integrated circuit; and
   executing the firmware.
Clause 38. A processor-implemented method comprising, by an integrated circuit of a device:
   storing, at a first manufacturing site, a first firmware in the integrated circuit, the first firmware including information for decrypting a provisioning message and an application for firmware over-the-air (FOTA);
   receiving, by the integrated circuit, the provisioning message at a second manufacturing site, the provisioning message including a payload that is encrypted, the payload including a shared identity for FOTA;
   decrypting, by the integrated circuit using the information for decrypting the provisioning message, the encrypted payload of the provisioning message to obtain the shared identity for FOTA;
   storing the shared identity for FOTA in the integrated circuit;
   establishing a wireless communication link with a controller at a user site;
   obtaining an encrypted FOTA package from the controller via the wireless communication link, the encrypted FOTA package comprising a second firmware;
   decrypting, using the shared identity for FOTA, the encrypted FOTA package to obtain the second firmware; and
   installing the second firmware on the integrated circuit.

What is claimed is:

1. A method comprising, by an integrated circuit of a device:
receiving, at a first manufacturing site, a firmware comprising information for decrypting a provisioning message;
receiving the provisioning message at a second manufacturing site, the provisioning message comprising a payload that is encrypted, the payload including an intermediate certificate authority (CA) identity;
decrypting, using the information for decrypting the provisioning message, the encrypted payload of the provisioning message to obtain the intermediate CA identity; and
generating a device identity for the device using the intermediate CA identity.

2. The method of claim 1, wherein:
the payload includes a hash index;
the intermediate CA identity in the payload is encrypted using a hash value determined based on the hash index; and
decrypting the encrypted payload of the provisioning message comprises:
decrypting the encrypted payload of the provisioning message to obtain the hash index and the encrypted intermediate CA identity;
performing, from an address corresponding to the hash index, a hash operation on content of a memory space of the integrated circuit to determine the hash value; and
decrypting the encrypted intermediate CA identity using the hash value to obtain the intermediate CA identity.

3. The method of claim 1, wherein:
the firmware comprises a provisioning application; and
the integrated circuit is configured to execute the provisioning application to decrypt the encrypted payload of the provisioning message and generate the device identity for the device.

4. The method of claim 3, further comprising, after generating the device identity for the device, deleting the provisioning application from the integrated circuit.

5. The method of claim 1, wherein:
the firmware includes a shared identity for provisioning; and
the information for decrypting the provisioning message includes a private key of the shared identity for provisioning.

6. The method of claim 1, wherein the intermediate CA identity is associated with the second manufacturing site and has an expiration date.

7. The method of claim 1, wherein generating the device identity for the device using the intermediate CA identity comprises:
generating a private key and a public key for the device identity;
generating a certificate including the public key and a serial number for the device; and
signing the certificate using a private key of the intermediate CA identity.

8. The method of claim 1, wherein:
the integrated circuit includes a memory space for storing the firmware; and
the integrated circuit is locked before being transferred to the second manufacturing site to prevent reading the memory space from outside of the integrated circuit.

9. The method of claim 8, wherein the firmware in the memory space includes one or more option bytes to ensure that the integrated circuit is locked.

10. The method of claim 1, further comprising:
storing the device identity in a non-volatile memory space of the integrated circuit;
storing a certificate of the intermediate CA identity in the non-volatile memory space; and
deleting a private key of the intermediate CA identity from the integrated circuit.

11. The method of claim 1, wherein the firmware includes a certificate of at least one of a root authority, a certificate authority, a registration authority, or a firmware authority.

12. The method of claim 11, further comprising verifying the provisioning message with a public key of the certificate authority.

13. The method of claim 11, wherein the provisioning message is signed by the certificate authority or the registration authority.

14. The method of claim 1, wherein:
the payload of the provisioning message includes a shared identity for firmware over-the-air (FOTA); and
the firmware includes a bootloader for FOTA.

15. The method of claim 14, wherein:
the shared identity for FOTA in the payload of the provisioning message is encrypted; and
decrypting the encrypted payload of the provisioning message includes decrypting the encrypted shared identity for FOTA to obtain the shared identity for FOTA.

16. A method comprising:
providing a firmware to a first manufacturing site to install the firmware on a controller of a device, the firmware comprising a provisioning application and information for decrypting a provisioning message; and
sending the provisioning message to a second manufacturing site to provide the provisioning message to the controller, the provisioning message including a payload that is encrypted, the payload including an intermediate certificate authority (CA) identity,
wherein the provisioning application, when executed by the controller, causes the controller to perform operations comprising, at the second manufacturing site:
decrypting, using the information for decrypting the provisioning message, the encrypted payload of the provisioning message to obtain the intermediate CA identity; and
generating a device identity for the device using the intermediate CA identity.

17. The method of claim 16, wherein:
the payload includes a hash index;
the intermediate CA identity in the payload is encrypted using a hash value determined based on the hash index; and
decrypting the encrypted payload of the provisioning message comprises:
decrypting the encrypted payload of the provisioning message to obtain the hash index and the encrypted intermediate CA identity;
performing, from an address corresponding to the hash index, a hash operation on content of a memory space of an integrated circuit of the device to determine the hash value; and
decrypting the encrypted intermediate CA identity using the hash value to obtain the intermediate CA identity.

18. The method of claim 16, wherein:
the firmware includes a shared identity for provisioning; and
the information for decrypting the provisioning message includes a private key of the shared identity for provisioning.

19. The method of claim 16, wherein generating the device identity for the device using the intermediate CA identity comprises:
generating a private key and a public key for the device identity;
generating a certificate including the public key and a serial number for the device; and
signing the certificate using a private key of the intermediate CA identity.

20. A processor-implemented method comprising, by an integrated circuit of a device:
storing, at a first manufacturing site, a first firmware in the integrated circuit, the first firmware including information for decrypting a provisioning message and an application for firmware over-the-air (FOTA);
receiving, by the integrated circuit, the provisioning message at a second manufacturing site, the provisioning message including a payload that is encrypted, the payload including a shared identity for FOTA;
decrypting, by the integrated circuit using the information for decrypting the provisioning message, the encrypted payload of the provisioning message to obtain the shared identity for FOTA;
storing the shared identity for FOTA in the integrated circuit;
establishing a wireless communication link with a controller at a user site;
obtaining an encrypted FOTA package from the controller via the wireless communication link, the encrypted FOTA package comprising a second firmware;
decrypting, using the shared identity for FOTA, the encrypted FOTA package to obtain the second firmware; and
installing the second firmware on the integrated circuit.
